(19) United States
(12) Patent Application Publication
(10) Pub. No.: US 2026/0269888 A1
(43) Pub. Date: Sep. 10, 2026

(54) CALIBRATION FOR UPLINK/DOWNLINK RECIPROCITY

(71) Applicant: QUALCOMM Incorporated, San Diego, CA (US)

(72) Inventors: Hyojin LEE, San Diego, CA (US); Jing SUN, San Diego, CA (US); Yu ZHANG, San Diego, CA (US)

(21) Appl. No.: 19/071,075

(22) Filed: Mar. 5, 2025

(51) Int. Cl. H04B 7/0456; H04L 5/00; H04W 24/10; H04W 72/21

(52) U.S. Cl. CPC H04B 7/0456; H04L 5/0005; H04W 24/10; H04W 72/21

(57) ABSTRACT

Aspects relate to mechanisms for uplink precoding calibration for uplink/downlink reciprocity of non-codebook-based uplink precoding matrices based on power measurements of an uplink calibration reference signal. A UE can obtain a first uplink precoding matrix based on a downlink reference signal. The UE can then transmit an uplink calibration reference signal to a network entity. The uplink calibration reference signal includes a plurality of resources in which each resource is precoded with a respective second uplink precoding matrix having a respective phase shift from the first uplink precoding matrix. The UE can then receive a report from the network entity including one or more resource indexes identifying one or more resources of the plurality of resources having the highest received power(s) among the plurality of resources. Based on the report, the UE can calibrate the first uplink precoding matrix to produce a calibrated uplink precoding matrix.

### TECHNICAL FIELD

The technology discussed below relates generally to wireless communication systems, and more particularly, to calibration of non-codebook based uplink precoding matrices for uplink/downlink reciprocity.

### INTRODUCTION

In wireless communication systems, such as those specified under fifth generation (5G) systems, referred to as New Radio (NR) systems, sixth generation (6G) systems, and other future generations, a user equipment (UE) may be capable of communicating with a network entity over an air interface. Transmissions over the air interface from the network entity to the UE may be referred to as downlink (DL) transmissions, whereas transmissions over the air interface from the UE to the network entity may be referred to as uplink (UL) transmissions. In a DL transmission, the network entity may transmit DL control information (DCI) including one or more DL control channels, such as a physical downlink control channel (PDCCH), to the UE. In addition, the network entity may transmit DL data traffic on one or more DL traffic channels, such as a physical downlink shared channel (PDSCH), to the UE. In an UL transmission, the UE may transmit UL control information (UCI) including one or more UL control channels, such as a physical uplink control channel (PUCCH), to the network entity. In addition, the UE may transmit UL data traffic on one or more UL traffic channels, such as a physical uplink shared channel (PUSCH), to the network entity.

Multiple-Input Multiple-Output (MIMO) technology utilizes multiple antennas at the transmitter and receiver to improve communication performance, increase data rates, and increase capacity. Precoding is a technique used in MIMO communication systems to optimize spatial multiplexing gain and diversity gain and to mitigate interference. For example, in point-to-point MIMO systems, multiple data streams can be emitted from respective transmit antennas of a transmitter with appropriate and independent weightings to maximize the link throughput at the receiver.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) is provided. The UE includes one or more memories and one or more processors coupled to the one or more memories. The one or processors are configured to cause the UE to receive a downlink reference signal from a network entity, obtain a first uplink precoding matrix based on the downlink reference signal, and transmit an uplink calibration reference signal including a plurality of resources. Each of the plurality of resources is precoded with a respective second uplink precoding matrix having a respective phase shift from the first uplink precoding matrix. The one or more processors are further configured to cause the UE to receive a report from the network entity that includes a resource index identifying a resource of the plurality of resources having a highest received power among the plurality of resources.

Another example provides a method operable at a user equipment (UE). The method includes receiving a downlink reference signal from a network entity, obtaining a first uplink precoding matrix based on the downlink reference signal, and transmitting an uplink calibration reference signal including a plurality of resources. Each of the plurality of resources is precoded with a respective second uplink precoding matrix having a respective phase shift from the first uplink precoding matrix. The method further includes receiving a report from the network entity that includes resource index identifying a resource of the plurality of resources having a highest received power among the plurality of resources.

Another example provides an apparatus configured for wireless communication. The apparatus includes means for receiving a downlink reference signal from a network entity, means for obtaining a first uplink precoding matrix based on the downlink reference signal, and means for transmitting an uplink calibration reference signal including a plurality of resources. Each of the plurality of resources is precoded with a respective second uplink precoding matrix having a respective phase shift from the first uplink precoding matrix. The apparatus further includes means for receiving a report from the network entity that includes resource index identifying a resource of the plurality of resources having a highest received power among the plurality of resources.

Another example provides a non-transitory computer-readable medium having stored therein instructions executable by one or more processors of a UE to cause the UE to receive a downlink reference signal from a network entity, obtain a first uplink precoding matrix based on the downlink reference signal, and transmit an uplink calibration reference signal including a plurality of resources. Each of the plurality of resources is precoded with a respective second uplink precoding matrix having a respective phase shift from the first uplink precoding matrix. The non-transitory computer-readable medium further includes instructions therein executable by the one or more processors of the UE to cause the UE to receive a report from the network entity that includes a resource index identifying a resource of the plurality of resources having a highest received power among the plurality of resources.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system and an access network according to some aspects.

FIG. 2 is a diagram providing a high-level illustration of one example of a configuration of a disaggregated base station according to some aspects.

FIGS. 3A, 3B, 3C, and 3D are diagrams illustrating examples of a first 5G/NR frame, DL channels within a 5G/NR subframe, a second 5G/NR frame, and UL channels within a 5G/NR subframe, respectively.

FIG. 4 is a diagram illustrating an example of a codebook-based uplink multiple-input multiple-output (MIMO) procedure according to some aspects.

FIG. 5 is a signaling diagram illustrating an example of non-codebook-based (NCB-based) uplink multiple-input multiple-output (MIMO) signaling according to some aspects.

FIG. 6 is a diagram illustrating an example of uplink/downlink (UL/DL) reciprocity according to some aspects.

FIG. 7 is a signaling diagram illustrating exemplary signaling between a network entity and a UE for acquiring a phase error compensation matrix for calibration of an uplink precoding matrix according to some aspects.

FIGS. 8A-8C are diagrams illustrating an example of an uplink calibration reference signal according to some aspects.

FIGS. 9A and 9B are diagrams illustrating another example of an uplink calibration reference signal according to some aspects.

FIGS. 10A and 10B are diagrams illustrating another example of an uplink calibration reference signal according to some aspects.

FIG. 11 is a signaling diagram illustrating other exemplary signaling between a network entity and a UE for acquiring a phase error compensation matrix for calibration of an uplink precoding matrix according to some aspects.

FIG. 12 is a signaling diagram illustrating other exemplary signaling between a network entity and a UE for acquiring a phase error compensation matrix for calibration of an uplink precoding matrix according to some aspects.

FIG. 13 is a signaling diagram illustrating other exemplary signaling between a network entity and a UE for acquiring a phase error compensation matrix for calibration of an uplink precoding matrix according to some aspects.

FIG. 14 is a flow chart illustrating an exemplary process for a UE to manage collisions with uplink calibration reference signals according to some aspects.

FIG. 15 is a block diagram illustrating an example of a hardware implementation for a UE employing a processing system according to some aspects.

FIG. 16 is a flow chart illustrating an exemplary process for uplink precoding calibration according to some aspects.

FIG. 17 is a flow chart illustrating another exemplary process 1700 for uplink precoding calibration according to some aspects.

FIG. 18 is a block diagram illustrating an example of a hardware implementation for a network entity employing a processing system according to some aspects.

FIG. 19 is a flow chart illustrating another exemplary process for uplink precoding calibration according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

Multiple-Input Multiple-Output (MIMO) is a wireless communication technology that uses multiple antennas at both the transmitter and receiver to enable simultaneous transmission of multiple data streams over the same radio channel using spatial multiplexing and precoding of the data streams. Precoding typically involves multiplying an input data vector by a precoding matrix to apply appropriate and independent weightings to each of the data streams based on knowledge of the wireless channel conditions. Codebook-based precoding utilizes a predefined set of precoding matrices, known as a codebook. Non-codebook-based precoding refers to a mechanism in which the transmission strategy (precoding) is determined without relying on a predefined codebook.

Although codebook (CB)-based uplink MIMO communications are relatively straightforward to implement, codebooks provided limited resolution, offering only a limited number of supported precoding matrices. Non-codebook (NCB)-based UL MIMO communications allows for higher-resolution precoding, and therefore can provide up to a 14.5 percent gain compared to CB-based UL MIMO. However, NCB-based UL MIMO communications assume UL/DL reciprocity, which is difficult to achieve at the UE due to residual phase errors in the radio frequency (RF) components of the UE. As a result, NCB-based UL MIMO has not been widely commercialized in mobile networks.

To achieve UL/DL reciprocity, a UE can be configured to calibrate an uplink precoding matrix to accommodate phase errors in the uplink precoding matrix. In particular, a UE can be configured to acquire a phase error compensation matrix and apply the phase error compensation matrix to an uplink precoding matrix to produce a calibrated uplink precoding matrix.

Various aspects are related to acquiring a phase error compensation matrix based on received power measurements of an uplink calibration reference signal. A UE may obtain a first uplink precoding matrix based on measurements of a downlink reference signal, such as a CSI-RS. The UE may then transmit an uplink calibration reference signal to a network entity. The uplink calibration reference signal includes a plurality of resources in which each resource is precoded with a respective second uplink precoding matrix having a respective phase shift from the first uplink precoding matrix. The network entity can measure the received power (e.g., reference signal received power (RSRP)) of each resource of the plurality of resources. In addition, the network entity can provide a report to the UE including one or more resource indexes identifying one or more resources of the plurality of resources having the highest received power(s) among the plurality of resources. The UE may then identify a phase calibration error based on the respective phase shift(s) associated with the identified resource(s) and apply a phase error compensation matrix corresponding to the phase calibration error to the first uplink precoding matrix to produce a calibrated uplink precoding matrix. The UE may then precode an uplink signal with the calibrated uplink precoding matrix for transmission to the network entity. The uplink precoding calibration mechanism described herein provides a simple and efficient manner to calibrate NCB-based uplink precoding matrices with minimal complexity at the UE and network entity.

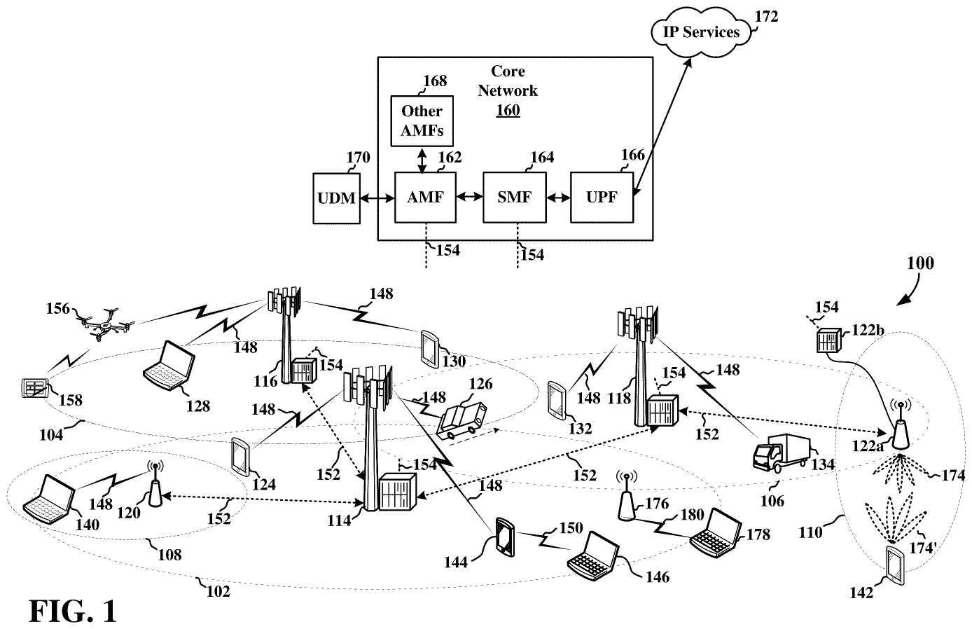

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

Deployment of communication systems, such as 5G new radio (NR) systems or 6G wireless systems, may be arranged in multiple manners with various components or constituent parts. In a 5G NR system or 6G system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

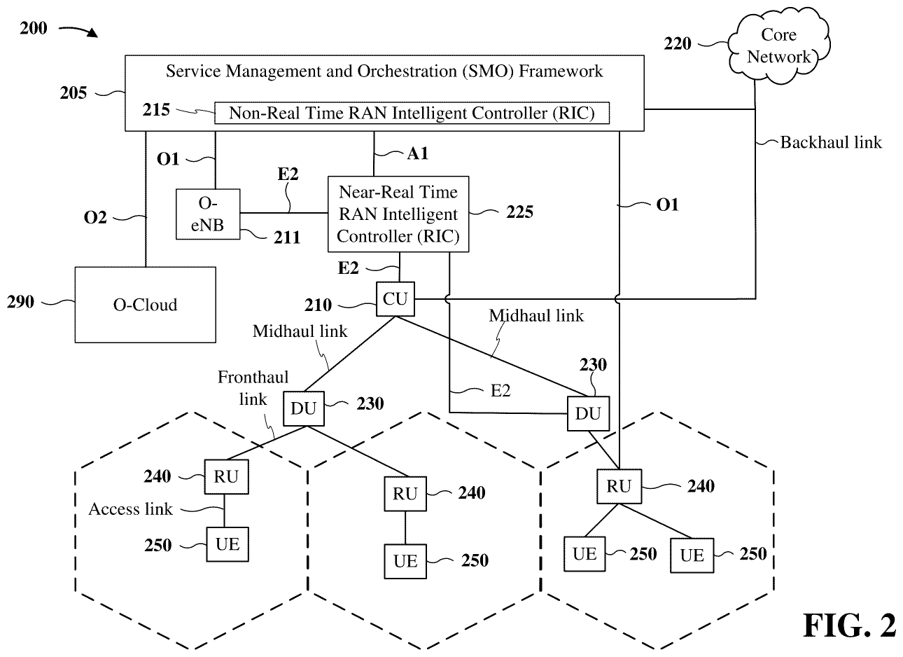

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 2rd Generation Partnership Project (2GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

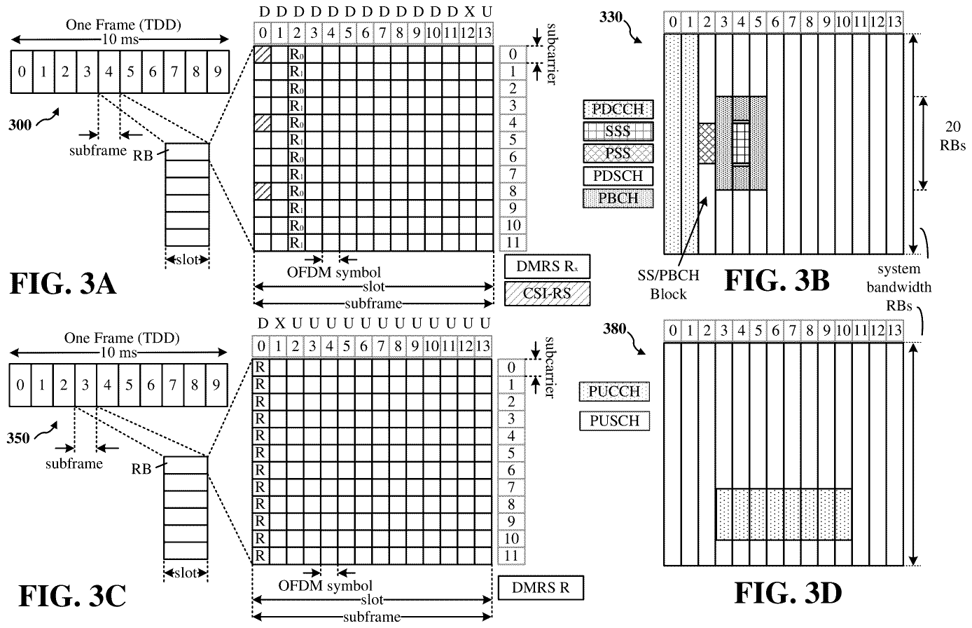

FIG. 3A is a diagram 300 illustrating an example of a first subframe within a 5G/NR frame structure. FIG. 3B is a diagram 330 illustrating an example of DL channels within a 5G/NR subframe. FIG. 3C is a diagram 350 illustrating an example of a second subframe within a 5G/NR frame structure. FIG. 3D is a diagram 380 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 3A, 3C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

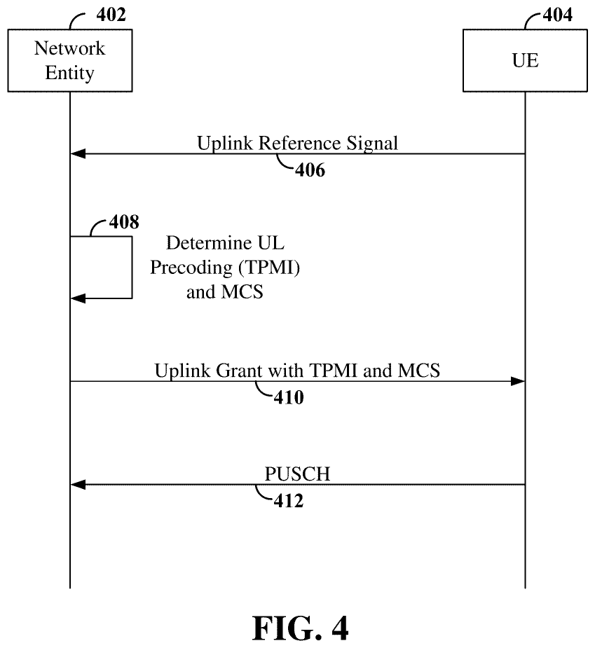

FIG. 4 is a signaling diagram illustrating an example of codebook-based uplink multiple-input multiple-output (MIMO) signaling between a network entity 402 and a user equipment (UE) 404 according to some aspects. The UE 404 may correspond to any of the UEs or other wireless communication devices shown in any of FIGS. 1 and/or 2. The network entity 402 may correspond to any of the base stations or other network entities shown in FIGS. 1 and/or 2. For example, the network entity 402 may correspond to an aggregated base station, an RU, a DU, a CU, a TRP, an IAB node, or other network device.

At 406, the UE 404 may transmit an uplink reference signal, such as an SRS, to the network entity 402. In some examples, the UE 404 may transmit a set of non-precoded SRSs to the network entity 402. The network entity 402 may then measure the SRS(s) to estimate channel conditions, such as interference and noise information. For example, the network entity may estimate the channel state information based on, for example, the path loss, propagation delay, and received signal strength of the received SRS. At 408, based on the channel state information derived from the SRS, the network entity 402 may determine a precoding (e.g., transmit precoding matrix indicator (TPMI)) and modulation and coding scheme (MCS) for uplink transmissions from the UE 404 to the network entity 402. For example, the network entity 402 may select a codebook and TPMI value to indicate the precoder to use from that selected codebook based on the channel state information. The MCS may be calculated, for example, based on the precoding selected by the network entity 402.

At 410, the network entity 402 may send the UE 404 an uplink grant of uplink resources on which to transmit an uplink transmission, such as a PUSCH. The uplink grant may include, for example, a MCS index that indicates the selected MCS and the TPMI that indicates the selected precoding matrix to apply to the uplink transmission. The uplink grant may further include an SRS resource indicator (SRI) indicating the beam(s) on which to transmit the uplink transmission. In some examples, the uplink grant may further include a number of layers, a number of antenna ports, a maximum rank, and/or other suitable information. At 412, the UE 404 can send a PUSCH transmission on the granted uplink resources, based on the TPMI and MCS received at 410.

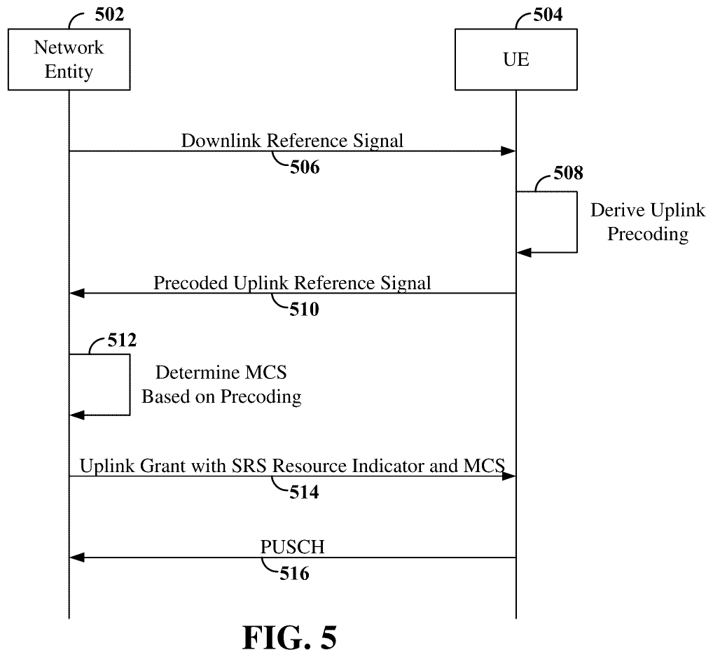

FIG. 5 is a signaling diagram illustrating an example of non-codebook-based (NCB-based) uplink multiple-input multiple-output (MIMO) signaling between a network entity 502 and a user equipment (UE) 504 according to some aspects. The UE 504 may correspond to any of the UEs or other wireless communication devices shown in any of FIGS. 1 and/or 2. The network entity 502 may correspond to any of the base stations or other network entities shown in FIGS. 1 and/or 2. For example, the network entity 502 may correspond to an aggregated base station, an RU, a DU, a CU, a TRP, an IAB node, or other network device.

At 506, the network entity 502 transmits a downlink reference signal, such as a CSI-RS, to the UE 504. In some examples, the network entity 502 may transmit a set of non-precoded CSI-RSs to the UE 504. The UE 504 may then measure the CSI-RS(s) to estimate channel conditions, such as interference and noise information. For example, the UE 504 may compute a channel matrix and/or one or more CSI parameters based on, for example, the path loss, propagation delay, and received signal strength of the received CSI-RS. At 508, the UE 504 then derives the precoding (e.g., a precoding matrix) for an uplink transmission from the channel state information. The precoding is non-codebook-based, which provides for higher resolution than codebook-based precoding.

At 510, the UE 504 transmits a set of one or more precoded SRSs to the network entity 502. The precoded SRS(s) are precoded based on the derived precoding determined by the UE 504. At 512, the network entity 502 determines a modulation and coding scheme (MCS) for uplink transmissions based on the precoding applied to the SRS(s). At 514, the network entity 502 may send the UE 504 an uplink grant of uplink resources on which to transmit an uplink transmission, such as a PUSCH. The uplink grant may include, for example, a MCS index that indicates the selected MCS and an SRS resource indicator (SRI) indicating the beam(s) on which to transmit the uplink transmission. In some examples, the uplink grant may further include a number of layers, a number of antenna ports, a maximum rank, and/or other suitable information. At 516, the UE 504 can send a PUSCH transmission on the granted uplink resources, based on the predefined precoding (e.g., precoding selected by the UE 504 at 508) and the MCS received at 514.

Although non-codebook-based UL MIMO communications allows for higher-resolution precoding (e.g., by increasing the number of available precoding matrices), as well as allowing for the use of precoding at the subband granularity, non-codebook based UL MIMO communications assume UL/DL reciprocity. However, achieving UL/DL reciprocity may be difficult to maintain, especially at the UE side.

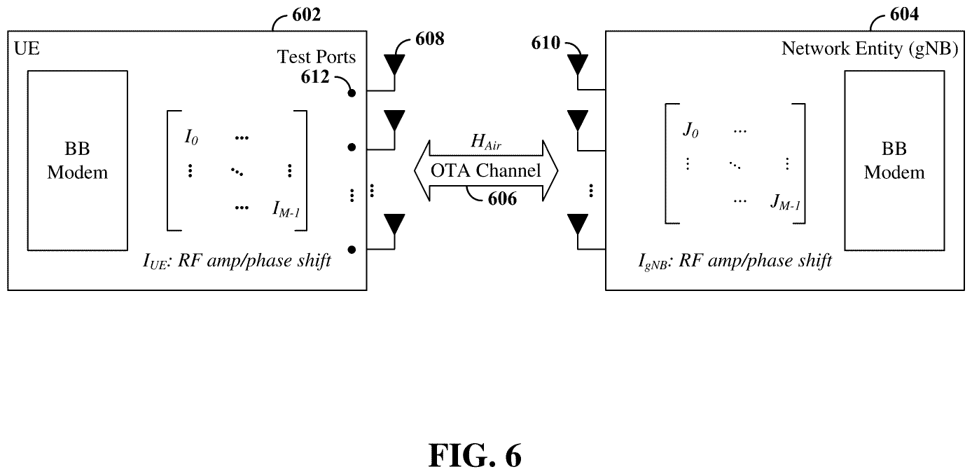

FIG. 6 is a diagram illustrating an example of uplink/downlink (UL/DL) reciprocity between a UE 602 and a network entity 604 according to some aspects. The UE 602 may correspond to any of the UEs or other wireless communication devices shown in any of FIGS. 1 and/or 2. The network entity 604 may correspond to any of the base stations or other network entities shown in FIGS. 1 and/or 2. For example, the network entity 604 may correspond to an aggregated base station, an RU, a DU, a CU, a TRP, an IAB node, or other network device.

In the example shown in FIG. 6, the UE 602 and network entity 604 communicate via an N×M MIMO over-the-air (OTA) channel 606 (H_{Air}), where N refers to a number of transmit antennas 608 (transmit antenna ports) at the UE 602 and M refers to a number of receive antennas 610 (receive antenna ports) at the network entity 604. The N×M OTA channel (H_{Air}) is generally reciprocal between the UL and DL in time division duplex (TDD) systems. However, the effective N×M MIMO channel can be decomposed as:

$$H = {I}_{gNB} {H}_{A i r} {I}_{U E} , \qquad ( Equation 1 )$$

where I_{UE} is an N×N diagonal matrix representing RF amplitude and phase shifts of RF components in the UE 602 and I_{gNB} is an M×M diagonal matrix representing RF amplitude and phase shifts of RF components at the network entity 604.

On the network entity 604 side, a calibration can be performed to align UL/DL RF amplitude and phase shifts. As a result, it can be assumed that I_{gNB} is reciprocal between the UL and DL. On the UE 602 side, the amplitude of I_{UE} can be calibrated using, for example, test ports 612 located adjacent to the UE antennas 608. However, the phase of I_{UE} is difficult for the UE to self-calibrate due to the complexity of implementation of an accurate phase measurement circuit and phase-jump events coming from RF parameter updates.

Thus, after gNB UL/DL amplitude and phase calibration and UE UL/DL amplitude calibration, the UL MIMO channel can be represented as:

$${H}_{U L} = {H}_{D L}^{T} \cdot {e}^{j {ϕ}_{0}} \cdot diag [ 1 , {e}^{j {ϕ}_{1}} , … , {e}^{j {ϕ}_{M - 1}} ] , \qquad ( Equation 2 )$$

where φₘ is the residual phase error after UL/DL reciprocity calibration of the m-th UE antenna port. In this example, the residual phase error is not frequency-selective, but rather a wideband parameter. Therefore, given the residual phase calibration error [1, e^{jφ}^{₁}, . . . , e^{jφ}^{_{M−1}}], if P is the optimal precoding calculated based on the downlink CSI-RS measurement, the actual optimal uplink precoding may be represented as:

$$\hat{P} = diag [ {e}^{- j {ϕ}_{1}} , … , {e}^{- j {ϕ}_{M - 1}} ] \cdot P , \qquad ( Equation 3 )$$

where diag [e^{jφ}^{₁}, . . . , e^{jφ}^{_{M−1}}] represents the phase error compensation matrix E:

$$E = diag [ {e}^{- j {ϕ}_{1}} , … , {e}^{- j {ϕ}_{M - 1}} ] . \qquad ( Equation 4 )$$

Therefore, to ensure UL/DL reciprocity in TDD, the UE 602 can acquire the phase error compensation matrix E. One straightforward mechanism to acquire the phase error compensation matrix E is based on measurement by the network entity 604. For example, the network entity 604 can measure the phase from an M-port SRS and report the phase measurement to the UE 602. In an example, the UE 602 may transmit an M-port SRS, and the network entity 604 can calculate and report an uplink phase matrix

$$( {Θ}_{U L} = diag ( 1 , {e}^{j {θ}_{1}^{U L}} , … , {e}^{j {θ}_{M - 1}^{U L}} ) )$$

to the UE 602. The UE 602 can further derive the downline phase matrix

$$( {Θ}_{D L} = diag ( 1 , {e}^{j {θ}_{1}^{D L}} , … , {e}^{j {θ}_{M - 1}^{D L}} ) )$$

based on a CSI-RS measurement and phase matrix then derive the phase error compensation matrix as:

$$E = {Θ}_{D L} {Θ}_{U L}^{*} . \qquad ( Equation 5 )$$

However, the above phase error compensation matrix acquisition mechanism involves additional complexity at the network entity 604. For example, the network entity 604 must estimate the channel of an M-port SRS and then derive the phase matrix based on the channel estimation for UE reciprocity compensation.

Therefore, various aspects are related to mechanisms for acquiring the UE phase error compensation matrix to facilitate NCB-based UL MIMO with reduced complexity at the network entity. In some examples, the UE 602 may acquire the phase error compensation matrix based on uplink reference signal received power measurements and resource index reporting by the network entity 604. For example, the UE 602 can transmit an uplink calibration reference signal including a plurality of resources and the network entity 604 can report the reference signal resource index of the resource associated with the highest received power to the UE 602.

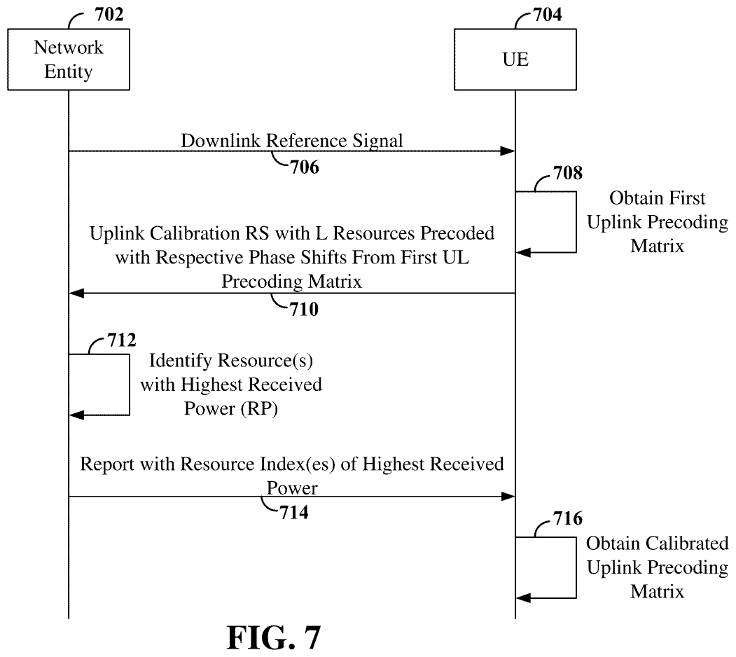

FIG. 7 is a signaling diagram illustrating exemplary signaling between a network entity 702 and a UE 704 for acquiring a phase error compensation matrix for calibration of an uplink precoding matrix according to some aspects. The UE 704 may correspond to any of the UEs or other wireless communication devices shown in any of FIGS. 1, 2, and/or 6. The network entity 702 may correspond to any of the base stations or other network entities shown in FIGS. 1, 2 and/or 6. For example, the network entity 702 may correspond to an aggregated base station, an RU, a DU, a CU, a TRP, an IAB node, or other network device.

At 706, the network entity 702 may send a downlink reference signal, such as a CSI-RS, to the UE 704. In some examples, the network entity 702 may transmit a set of non-precoded CSI-RSs to the UE 704. The UE 704 may then measure the CSI-RS(s) to estimate channel state information based on, for example, the path loss, propagation delay, and received signal strength of the received CSI-RS. At 708, the UE 704 then obtains a first uplink precoding matrix for an uplink transmission based on the channel state information. The first uplink precoding matrix is non-codebook-based, which provides for higher resolution than codebook-based precoding.

At 710, the UE 704 transmits an uplink calibration reference signal (RS) with a plurality of resources (e.g., L resources), each precoded with a respective phase shift from the first uplink precoding matrix. For example, each of the L resources of the uplink calibration reference signal may be precoded with a respective second uplink precoding matrix having a respective phase shift from the first uplink precoding matrix. In some examples, the uplink calibration reference signal may correspond to an SRS or other suitable uplink reference signal.

At 712, the network entity 702 can measure the respective power (e.g., reference signal received power (RSRP)) of each of the L resources and identify the resource or resources having the highest received power. In some examples, the network entity 702 identifies a single resource with the highest received power. In other examples, the network entity 702 identifies the K resources out of the total L resources with the highest received powers, where L>K>1.

At 714, the network entity 702 sends a report to the UE 704 including the resource index(es) identifying the resource(s) having the highest received power among the plurality of resources. At 716, the UE 704 can calibrate the first uplink precoding matrix based on the identified resources with the highest power to obtain a calibrated uplink precoding matrix. For example, the UE 704 can identify a phase calibration error corresponding to the phase error compensation matrix E based on the respective phase shift(s) associated with the reported resource(s) having the highest power. The UE 704 can then apply a phase error compensation matrix corresponding to the phase calibration error to the first uplink precoding matrix to produce the calibrated uplink precoding matrix. The UE 704 may then use the calibrated uplink precoding matrix to transmit an uplink signal (e.g., an SRS or PUSCH) to the network entity 702. For example, the UE 704 may send a set of precoded SRSs to the network entity 702 to obtain the MCS and then use the MCS to subsequently transmit a PUSCH as illustrated in FIG. 5.

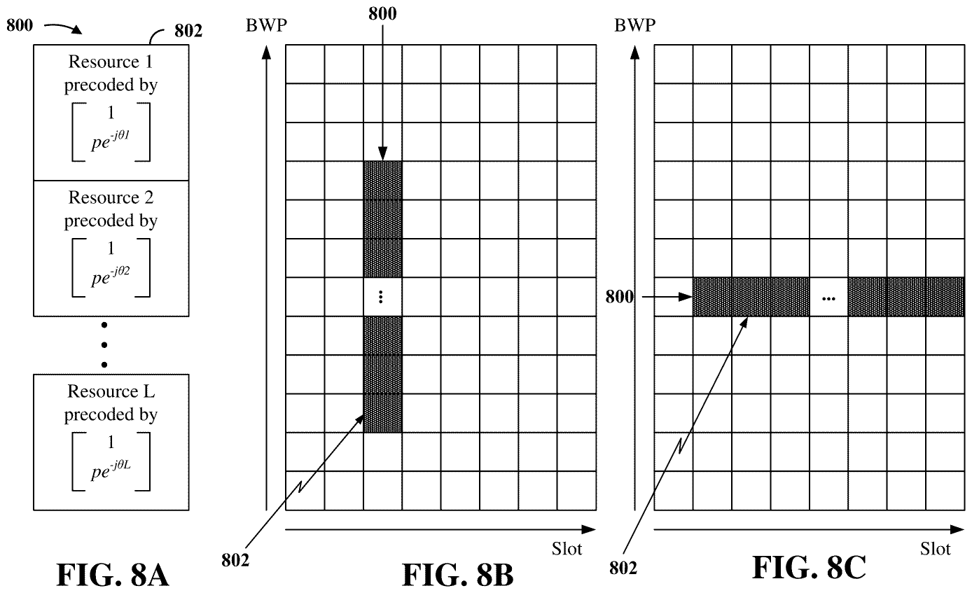

FIGS. 8A-8C are diagrams illustrating an example of an uplink calibration reference signal according to some aspects. The uplink calibration reference signal 800 shown in FIG. 8A includes a plurality of resources 802. Each resource 802 corresponds to a respective time-frequency resource on which a symbol or symbols of the calibration reference signal are transmitted. In the example shown in FIGS. 8B and 8C, resources 802 may correspond to frequency resources within a bandwidth part (BWP) and time resources within one or more symbols of a slot.

The example shown in FIGS. 8A-8C represents a case of 2 Tx UL MIMO. In this example, if the UE determines the best rank-1 precoding

$$p = [ \begin{matrix}1 \\ p\end{matrix} ]$$

(e.g., the first uplink precoding matrix) based on downlink CSI-RS measurement, the actual optimal uplink precoding may be represented as:

$$\hat{p} = [ \begin{matrix}1 \\ p {e}^{- j {ϕ}_{1}}\end{matrix} ] , \qquad ( Equation 6 )$$

where φ₁ is the residual phase calibration error.

The UE can then transmit an UL RS (e.g., uplink calibration reference signal 800) including L resources 802, each of which transmits a single-port signal precoded by

$$[ \begin{matrix}1 \\ p {e}^{- j {θ}_{l}}\end{matrix} ] ,$$

where pe^{-jθ}^{ᵢ} represents a phase shift from the original derived precoding p (e.g., the first uplink precoding matrix). For example, the UE may precode the first resource by

$$[ \begin{matrix}1 \\ p {e}^{- j {θ}_{1}}\end{matrix} ] ,$$

the second resource by

$$[ \begin{matrix}1 \\ p {e}^{- j {θ}_{2}}\end{matrix} ]$$

and the L-th resource by

$$[ \begin{matrix}1 \\ p {e}^{- j {θ}_{L}}\end{matrix} ] .$$

Thus, each resource 802 is precoded with a respective second uplink precoding matrix having a respective phase shift from the first uplink precoding matrix.

The network entity may then measure the respective received power of each of the L resources, and determine the RS resource with the highest received power among the L resources. The RS resource with the highest received power may correspond, for example, to the resource precoded by

$$[ \begin{matrix}1 \\ p {e}^{- j {θ}_{\hat{l}}}\end{matrix} ] ,$$

where:

$$\hat{l} = {arg}_{l ∈ \{ 1 , … , L \}} min \vert {θ}_{l} - {ϕ}_{1} \vert . \qquad ( Equation 7 )$$

The network entity can then report to the UE the RS resource index associated with the highest received power. Based on the report, the UE can determine the residual phase calibration error φ₁ in an L-step quantized manner within a certain range. A phase error compensation matrix corresponding to the phase calibration error may then be applied to the first uplink precoding matrix to produce the calibrated uplink precoding matrix.

Since the UE may select what is transmitted over each RS resource, the UE may implement a telescoping design that over time zooms in on the focus with limited choices for each transmission if higher resolution is needed. For example, each of the respective first phase shifts from the first uplink precoding matrix for each of the resources may be quantized within a first range for a first uplink calibration reference signal. The UE may then transmit a second uplink calibration reference signal including a plurality of additional resources that are each precoded based on a respective second phase shift from the first uplink precoding matrix quantized within a second range, where the second range is a subset of the first range. This process may be repeated multiple times to drill down on the resolution of the phase error compensation matrix applied to the first uplink precoding matrix to produce the calibrated uplink precoding matrix.

In some examples, the network entity can provide a calibration reference signal configuration for the uplink calibration reference signal that includes various parameters. For example, the network entity may transmit a calibration reference signal configuration (e.g., an RRC configuration, MAC-CE configuration, and/or DCI configuration) that includes a number of resources (e.g., to apply different phase-shift values) and the time/frequency location of the calibration RS (e.g., the RS resource allocation). In some examples, the calibration reference signal configuration may further include a repetition factor of the RS (e.g., to give a power combining gain for cell-edge UEs) and/or a frequency hopping parameter to enable different frequency locations to be applied in different symbols of the calibration reference signal. In some examples, the calibration reference signal configuration may indicate a periodicity of transmission of the uplink calibration reference signal. In this example, the transmission timing (e.g., in terms of period and offset) may be configured via RRC. In some examples, the calibration reference signal configuration may further indicate the report timing and/or resources for the network entity to report the best resource index or best-K resource indices. In other examples, the report resources may be scheduled by the network entity via DCI or MAC-CE.

In some examples, the calibration reference signal may be located on contiguous L resources in uplink slots. For example, as shown in FIG. 8B, the resources 802 may be located on adjacent frequency resources. As another example, as shown in FIG. 8C, the resources 802 may be located on adjacent time resources (e.g., adjacent symbols of a slot). Since the residual phase error is frequency-flat and not time-varying within a given slot, the calibration RS does not need to be a wideband signal nor a long time-spanning signal. In addition, the L resources to apply different phase shift values (θ₁, . . . , θ_{L}) can be multiplexed in a TDM, FDM, and/or CDM manner. FIG. 8B illustrates an example of FDM or FDM/CDM multiplexing, whereas FIG. 8C illustrates an example of TDM or TDM/CDM multiplexing. To produce an accurate phase-error value, the L resources may be located as adjacent as possible, as illustrated in FIGS. 8B and 8C. In addition, when a repetition factor greater than one is configured, multiple calibration RS transmissions may be repeated in the time domain.

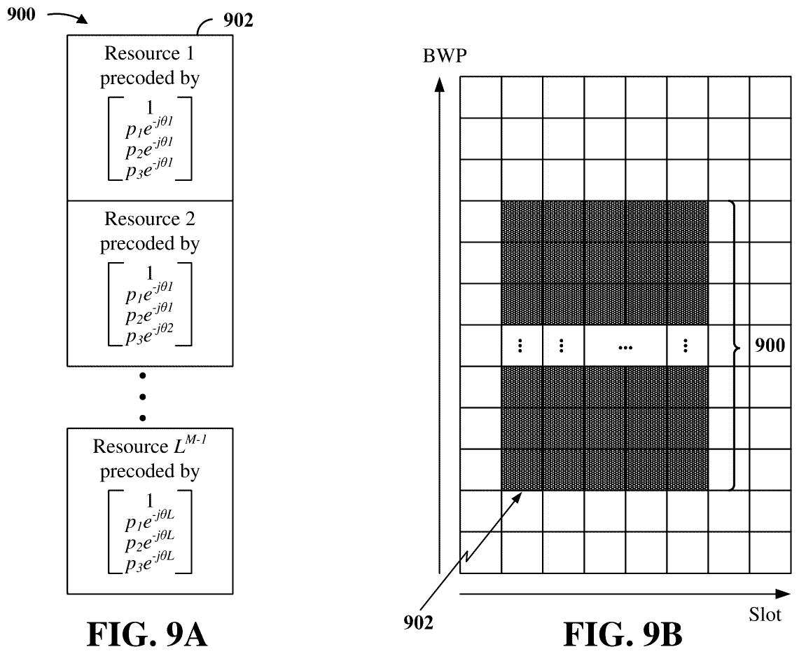

FIGS. 9A and 9B are diagrams illustrating another example of an uplink calibration reference signal according to some aspects. The uplink calibration reference signal 900 shown in FIG. 9A includes a plurality of resources 902. Each resource 902 corresponds to a respective time-frequency resource on which a symbol or symbols of the calibration reference signal are transmitted. In the example shown in FIG. 9B, resources 902 may correspond to frequency resources within a bandwidth part (BWP) and time resources within one or more symbols of a slot.

The example shown in FIGS. 9A and 9B is an extension of the example shown in FIGS. 8A-8C and represents a case of UL MIMO with M Tx antennas. In this example, the UE determines the (M−1) residual phase calibration errors (φ₁, . . . , φ_{M-1}) for reciprocity-based MIMO operation. To produce an L-step quantized phase value for each φₘ, a total of L^{M-1} phase shifts are identified for M antennas. The best rank-1 precoding matrix (e.g., first uplink precoding matrix) determined based on downlink CSI-RS measurement may be represented as:

$$p = {[ 1 , {p}_{1} , … {p}_{M - 1} ]}^{T} . \qquad ( Equation 8 )$$

Thus, the first uplink precoding matrix includes a first vector of precoding values, with element of the first vector being associated with an antenna port of the M antenna ports.

The UE may then transmit an uplink calibration reference signal 900 including L^{M-1} resources 902, each of which transmits a single-port signal precoded by [1, p₁e^{-jθ}^{ₗ₁}, . . . , p₁e^{-jθ}^{_{lM−1}}]^{T}, where lₘ∈{1, . . . }. For example, for four antenna ports (e.g., M=4), the UE may precode the first resource by

$$[ \begin{matrix}1 \\ {p}_{1} {e}^{- j {θ}_{1}} \\ {p}_{2} {e}^{- j {θ}_{1}} \\ {p}_{3} {e}^{- j {θ}_{1}}\end{matrix} ] ,$$

the second resource by

$$[ \begin{matrix}1 \\ {p}_{1} {e}^{- j {θ}_{1}} \\ {p}_{2} {e}^{- j {θ}_{1}} \\ {p}_{3} {e}^{- j {θ}_{2}}\end{matrix} ]$$

and the L^{M-1}-th resource by

$$[ \begin{matrix}1 \\ {p}_{1} {e}^{- j {θ}_{L}} \\ {p}_{2} {e}^{- j {θ}_{L}} \\ {p}_{3} {e}^{- j {θ}_{L}}\end{matrix} ] .$$

Thus, each resource 902 is precoded with a respective second uplink precoding matrix having a respective second vector of precoding values (e.g., M precoding values). Each element of each of the respective second vectors includes a respective phase shift from a corresponding element of the first vector. In this example, the respective phase shift (e.g., e^{-jθ}^{ᵢ}) is equal across the respective elements of a given second vector. As indicated above, the number of resources 902 is based on the number of antenna ports (e.g., there are L^{M-1} resources 902).

The network entity may then measure the respective received power of each of the L^{M-1} resources, and determine the calibration RS resource with the highest received power among the L resources. The RS resource with the highest received power may correspond, for example, to the resource precoded with the vector closest to [1, p₁e^{-jθ}^{ₗ₁}, . . . , p₁e^{-jθ}^{_{lM−1}}]^{T}.

The network entity can then report to the UE the RS resource index associated with the highest received power. Based on the report, the UE can determine the (M−1) residual phase calibration errors (φ₁, . . . , φ_{M-1}) in an L-step quantized manner within a certain range. A phase error compensation matrix corresponding to the phase calibration errors may then be applied to the first uplink precoding matrix to produce the calibrated uplink precoding matrix.

Since the UE may select what is transmitted over each RS resource, to extend the example shown in FIGS. 8A-8C to support the M-Tx case, the size of the uplink calibration reference signal (e.g., the number of resources) can be increased. To support a larger sized uplink calibration reference signal 900, the calibration RS resources 902 may span both time and/or frequency, as illustrated in FIG. 9B.

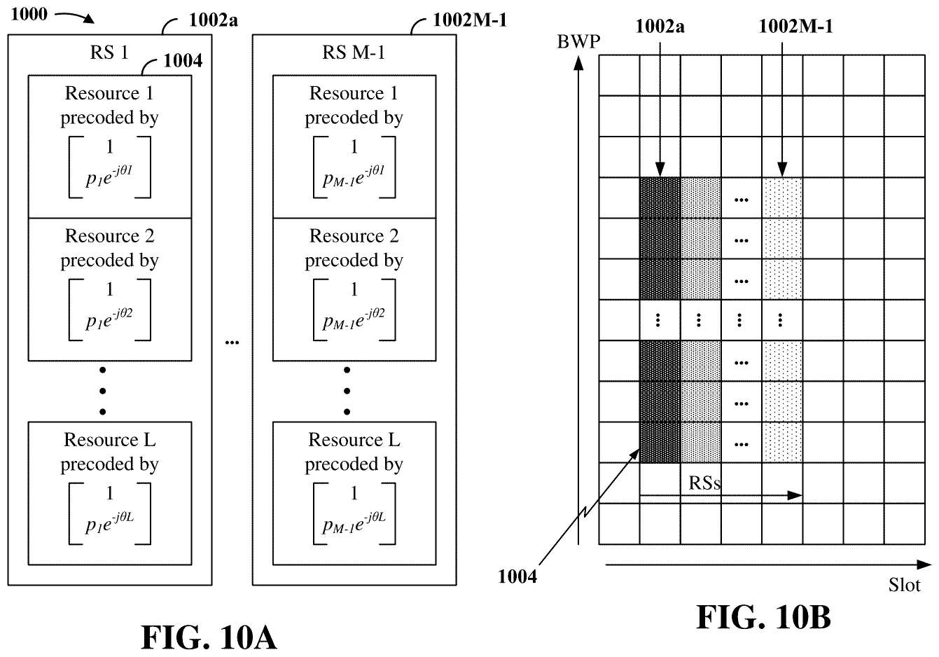

FIGS. 10A and 10B are diagrams illustrating another example of an uplink calibration reference signal according to some aspects. The uplink calibration reference signal 1000 shown in FIG. 10A includes a set of two or more uplink calibration reference signals 1002a, . . . , 1002M−1, each including a plurality of resources 1004. Each resource 1004 corresponds to a respective time-frequency resource on which a symbol or symbols of the calibration reference signal are transmitted. In the example shown in FIG. 10B, resources 1004 may correspond to frequency resources within a bandwidth part (BWP) and time resources within one or more symbols of a slot.

The example shown in FIGS. 10A and 10B is also an extension of the example shown in FIGS. 8A-8C, but represents a one-by-one extension for a case of UL MIMO with M Tx antennas. As in the example shown in FIGS. 9A and 9B, the UE is configured to determine the (M−1) residual phase calibration errors (φ₁, . . . , φ_{M-1}) for reciprocity-based MIMO operation. However, as shown in FIGS. 10A and 10B, for each calibration error φₘ (m=1, . . . . M−1), the same 2Tx case operation as shown in FIG. 8A is used and the best RS resource index is reported by the network entity. Again, the best rank-1 precoding matrix (e.g., first uplink precoding matrix) determined based on downlink CSI-RS measurement may be identified as shown in Equation 8 above. Thus, the first uplink precoding matrix includes a first vector of precoding values, with each element of the first vector being associated with an antenna port of the M antenna ports.

The UE can then generate and transmit (M−1) uplink calibration reference signals 1002a, . . . , 1002M−1, each including L resources. For example, for the m-th uplink calibration reference signal, each resource 1004 transmits a single-port signal precoded by

$$[ \begin{matrix}1 \\ {p}_{m} {e}^{- j {θ}_{l}}\end{matrix} ]$$

using the first and m-th antenna ports and muting all of the other antenna ports on that resource. For example, the first uplink calibration reference signal 1002a may use two antenna ports (e.g., antenna ports 0 and 1). In this example, the UE may precode the first resource 1004 of the first uplink calibration reference signal 1002a by

$$[ \begin{matrix}1 \\ {p}_{1} {e}^{- j {θ}_{1}}\end{matrix} ] ,$$

the second resource of the first uplink calibration reference signal 1002a by

$$[ \begin{matrix}1 \\ {p}_{1} {e}^{- j {θ}_{2}}\end{matrix} ]$$

and the L-th resource of the first uplink calibration reference signal 1002a by

$$[ \begin{matrix}1 \\ {p}_{1} {e}^{- j {θ}_{L}}\end{matrix} ] .$$

Similarly, the M−1th uplink calibration reference signal 1002M−1 may use two antenna ports (e.g., antenna ports 0 and M−1). In this example, the UE may precode the first resource 1004 of the M−1 uplink calibration reference signal 1002M−1 by

$$[ \begin{matrix}1 \\ {p}_{M - 1} {e}^{- j {θ}_{1}}\end{matrix} ] ,$$

the second resource of the first uplink calibration reference signal 1002M−1 by

$$[ \begin{matrix}1 \\ {p}_{M - 1} {e}^{- j {θ}_{2}}\end{matrix} ]$$

and the L-th resource of the first uplink calibration reference signal 1002M−1 by

$$[ \begin{matrix}1 \\ {p}_{M - 1} {e}^{- j {θ}_{L}}\end{matrix} ] .$$

Thus, each resource 1004 in each of the uplink calibration reference signals 1002a, . . . , 1002M−1 is precoded with a respective second uplink precoding matrix having a respective phase shift from the first uplink precoding matrix. Here, each of the second uplink precoding matrices associated with a given uplink calibration reference signal (e.g., 1002a) is associated with a same set of two respective elements of the vector of the first uplink precoding matrix, corresponding to a respective set of two antenna ports (e.g., antenna ports 0 and 1) for the given uplink calibration reference signal 1002a.

The network entity may then measure the respective received power of each of the L resources for each of the uplink calibration reference signals 1002a, . . . , 1002M−1, and determine the RS resource with the highest received power among the L resources for each of the uplink calibration reference signals 1002a, . . . , 1002M−1. The network entity can then report to the UE the RS resource index associated with the highest received power for each uplink calibration reference signal 1002a, . . . , 1002M−1. Thus, the report may include (M−1) RS resource indices for the M−1 uplink calibration reference signals. The m-th RS resource index indicates the resource with the highest received power in the m-th uplink calibration reference signal. To expand to include the best-K resources per uplink calibration reference signal, the report may include (M−1) sets of the best or best-K resource indices based on the calibration RS measurement. The total number of bits for resource index reporting may then correspond to: (M−1)·┌log₂ L┘. Based on the report, the UE can determine the (M−1) residual phase calibration errors (φ₁, . . . , φ_{M-1}). A phase error compensation matrix corresponding to the phase calibration errors may then be applied to the first uplink precoding matrix to produce the calibrated uplink precoding matrix.

In some examples, the network entity can provide a calibration reference signal configuration for the uplink calibration reference signal including two or more uplink calibration reference signals. In some examples, the calibration reference signal configuration (e.g., an RRC configuration, MAC-CE configuration, and/or DCI configuration) may include a number of the two or more uplink calibration reference signal in addition to other parameters described above in connection with FIGS. 8A-8C. For example, the other parameters may include, but are not limited to, the number of resources (e.g., per uplink calibration reference signal 1002a, . . . , 1002M−1) and the resource location of the entire uplink calibration reference signal 1000. In other examples, the calibration reference signal configuration may include multiple sets of calibration reference signal resources, with each set indicating a respective number of resources and respective time/frequency location of the respective calibration RS 1002a, . . . , 1002M−1.

In some examples, each of the calibration reference signals 1002a, . . . , 1002M−1 may be located on contiguous L resources in uplink slots. For example, as shown in FIG. 10B, the resources 1004 for each calibration reference signal 1002a, . . . , 1002M−1 may be located on adjacent frequency resources. In addition, the respective resources 1004 across each of the two or more uplink calibration reference signals 1002a, . . . , 1002M−1 may be contiguous in at least one of time or frequency. In the example shown in FIG. 10B, the resources 1004 across the uplink calibration reference signals 1002a, . . . , 1002M−1 are contiguous in time (e.g., within contiguous symbols of a slot).

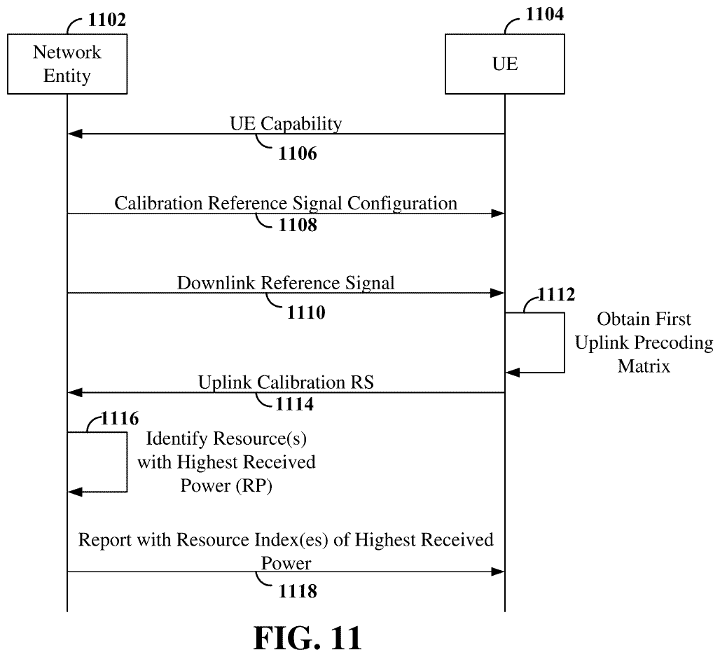

FIG. 11 is a signaling diagram illustrating other exemplary signaling between a network entity 1102 and a UE 1104 for acquiring a phase error compensation matrix for calibration of an uplink precoding matrix according to some aspects. The UE 1104 may correspond to any of the UEs or other wireless communication devices shown in any of FIGS. 1, 2, and/or 6. The network entity 1102 may correspond to any of the base stations or other network entities shown in FIGS. 1, 2 and/or 6. For example, the network entity 1102 may correspond to an aggregated base station, an RU, a DU, a CU, a TRP, an IAB node, or other network device.

At 1106, the UE 1104 can transmit a capability of the UE 1104 to the network entity 1102. The capability may indicate, for example, a number of resources (L) supported by or preferred by the UE 1104 for an uplink calibration reference signal. In examples in which the UE 1104 includes more than two antenna ports, the capability may further report on the number of supported or preferred sets (M−1) of calibration reference signal resources. In some examples, the number of sets (M−1) of calibration reference signal resources may not be included in the capability, as this information may be gleaned by the network entity 1102 based on the number of UE SRS antenna ports (M).

At 1108, the network entity 1102 can provide a calibration reference signal configuration to the UE 1104. The calibration reference signal configuration may indicate, for example, the number of resources (L) for an uplink calibration reference signal and/or the number of sets (M−1) of calibration reference signal resources based on the capability of the UE 1104 provided at 1106. The calibration reference signal configuration may include, for example, an RRC configuration, MAC-CE configuration, and/or DCI configuration. The calibration reference signal configuration may further include the time/frequency location of the uplink calibration reference signal, a repetition factor of the uplink calibration reference signal, a frequency hopping parameter for the uplink calibration reference signal, a periodicity of transmission of the uplink calibration reference signal, report timing and/or resources for the network entity to report the best resource index or best-K resource indices, and/or other parameters related to the uplink calibration reference signal. In some examples, the transmission timing (e.g., in terms of period and offset) of the uplink calibration reference signal may be configured via RRC.

At 1110, the network entity 1102 may send a downlink reference signal, such as a CSI-RS, to the UE 1104. In some examples, the network entity 1102 may transmit a set of non-precoded CSI-RSs to the UE 1104. The UE 1104 may then measure the CSI-RS(s) to estimate channel state information based on, for example, the path loss, propagation delay, and received signal strength of the received CSI-RS. At 1112, the UE 1104 then obtains a first uplink precoding matrix for an uplink transmission based on the channel state information. The first uplink precoding matrix is non-codebook-based, which provides for higher resolution than codebook-based precoding.

At 1114, the UE 1104 transmits an uplink calibration reference signal (RS) with a plurality of resources (e.g., L resources), each precoded with a respective phase shift from the first uplink precoding matrix. For example, each of the L resources of the uplink calibration reference signal may be precoded with a respective second uplink precoding matrix having a respective phase shift from the first uplink precoding matrix.

At 1116, the network entity 1102 can measure the respective power (e.g., reference signal received power (RSRP)) of each of the L resources and identify the resource or resources having the highest received power. In some examples, the network entity 1102 identifies a single resource with the highest received power. In other examples, the network entity 1102 identifies the K resources out of the total L resources with the highest received powers, where L>K>1.

At 1118, the network entity 1102 sends a report to the UE 1104 including the resource index(es) identifying the resource(s) having the highest received power among the plurality of resources. In some examples, the network entity 1102 schedules the resources for sending the report via MAC-CE and/or DCI. In other examples, the resources for sending the report are configured via the calibration reference signal configuration.

The UE 1104 can then calibrate the first uplink precoding matrix based on the identified resources with the highest power to obtain a calibrated uplink precoding matrix as illustrated in FIG. 7. For example, the UE 1104 can identify a phase calibration error corresponding to the phase error compensation matrix E based on the respective phase shift(s) associated with the reported resource(s) having the highest power. The UE 1104 can then apply the phase error compensation matrix to the first uplink precoding matrix to produce the calibrated uplink precoding matrix. The UE 1104 may then use the calibrated uplink precoding matrix to transmit an uplink signal (e.g., an SRS or PUSCH) to the network entity 1102. For example, the UE 1104 may send a set of precoded SRSs to the network entity 1102 to obtain the MCS and then use the MCS to subsequently transmit a PUSCH as illustrated in FIG. 5.

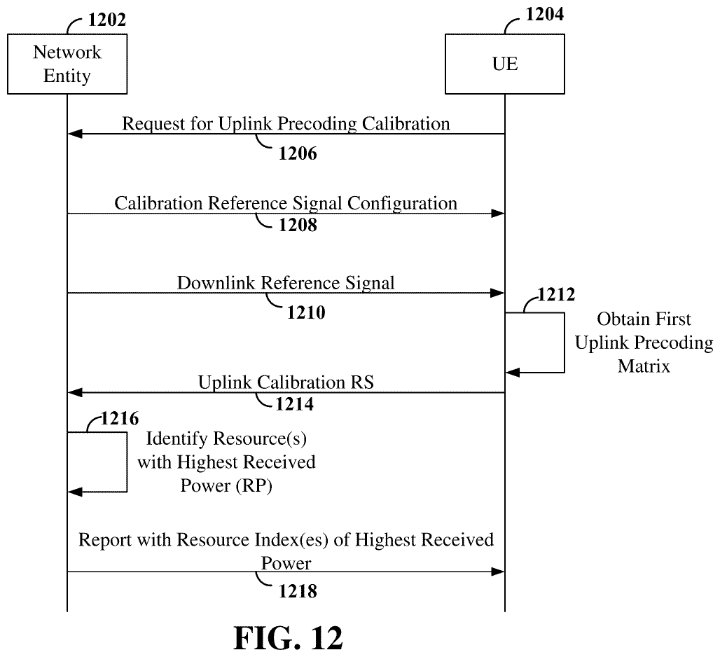

FIG. 12 is a signaling diagram illustrating other exemplary signaling between a network entity 1202 and a UE 1204 for acquiring a phase error compensation matrix for calibration of an uplink precoding matrix according to some aspects. The UE 1204 may correspond to any of the UEs or other wireless communication devices shown in any of FIGS. 1, 2, and/or 6. The network entity 1202 may correspond to any of the base stations or other network entities shown in FIGS. 1, 2 and/or 6. For example, the network entity 1202 may correspond to an aggregated base station, an RU, a DU, a CU, a TRP, an IAB node, or other network device.

At 1206, the UE 1204 may send a request for uplink precoding calibration to the network entity 1202. For example, the UE 1204 may send the request on a MAC-CE, PUCCH, or UCI.

At 1208, the network entity 1202 can provide a calibration reference signal configuration to the UE 1204. The calibration reference signal configuration may indicate, for example, the number of resources (L) for an uplink calibration reference signal and/or the number of sets (M−1) of calibration reference signal resources based on the capability of the UE 1204 provided at 1206. The calibration reference signal configuration may include, for example, an RRC configuration, MAC-CE configuration, and/or DCI configuration. The calibration reference signal configuration may further include the time/frequency location of the uplink calibration reference signal, a repetition factor of the uplink calibration reference signal, a frequency hopping parameter for the uplink calibration reference signal, a periodicity of transmission of the uplink calibration reference signal, report timing and/or resources for the network entity to report the best resource index or best-K resource indices, and/or other parameters related to the uplink calibration reference signal. In some examples, the transmission timing (e.g., in terms of period and offset) of the uplink calibration reference signal may be configured via RRC.

In some examples, the calibration reference signal configuration may be sent prior to the request for uplink precoding calibration. In this example, the request for uplink precoding calibration may be a request to trigger uplink precoding calibration. The network entity may then provide scheduling information to the UE that dynamically, semi-persistently, or periodically schedules one or more of a downlink reference signal and/or an uplink calibration reference signal based on the calibration reference signal configuration.

At 1210, the network entity 1202 may send a downlink reference signal, such as a CSI-RS, to the UE 1204. In some examples, the network entity 1202 may transmit a set of non-precoded CSI-RSs to the UE 1204. The UE 1204 may then measure the CSI-RS(s) to estimate channel state information based on, for example, the path loss, propagation delay, and received signal strength of the received CSI-RS. At 1212, the UE 1204 then obtains a first uplink precoding matrix for an uplink transmission based on the channel state information. The first uplink precoding matrix is non-codebook-based, which provides for higher resolution than codebook-based precoding.

At 1214, the UE 1204 transmits an uplink calibration reference signal (RS) with a plurality of resources (e.g., L resources), each precoded with a respective phase shift from the first uplink precoding matrix. For example, each of the L resources of the uplink calibration reference signal may be precoded with a respective second uplink precoding matrix having a respective phase shift from the first uplink precoding matrix.

At 1216, the network entity 1202 can measure the respective power (e.g., reference signal received power (RSRP)) of each of the L resources and identify the resource or resources having the highest received power. In some examples, the network entity 1202 identifies a single resource with the highest received power. In other examples, the network entity 1202 identifies the K resources out of the total L resources with the highest received powers, where L>K>1.

At 1218, the network entity 1202 sends a report to the UE 1204 including the resource index(es) identifying the resource(s) having the highest received power among the plurality of resources. In some examples, the network entity 1102 schedules the resources for sending the report via MAC-CE and/or DCI. In other examples, the resources for sending the report are configured via the calibration reference signal configuration.

The UE 1204 can then calibrate the first uplink precoding matrix based on the identified resources with the highest power to obtain a calibrated uplink precoding matrix as illustrated in FIG. 7. For example, the UE 1204 can identify a phase calibration error corresponding to the phase error compensation matrix E based on the respective phase shift(s) associated with the reported resource(s) having the highest power. The UE 1204 can then apply a phase error compensation matrix corresponding to the phase calibration error to the first uplink precoding matrix to produce the calibrated uplink precoding matrix. The UE 1204 may then use the calibrated uplink precoding matrix to transmit an uplink signal (e.g., an SRS or PUSCH) to the network entity 1202. For example, the UE 1204 may send a set of precoded SRSs to the network entity 1202 to obtain the MCS and then use the MCS to subsequently transmit a PUSCH as illustrated in FIG. 5.

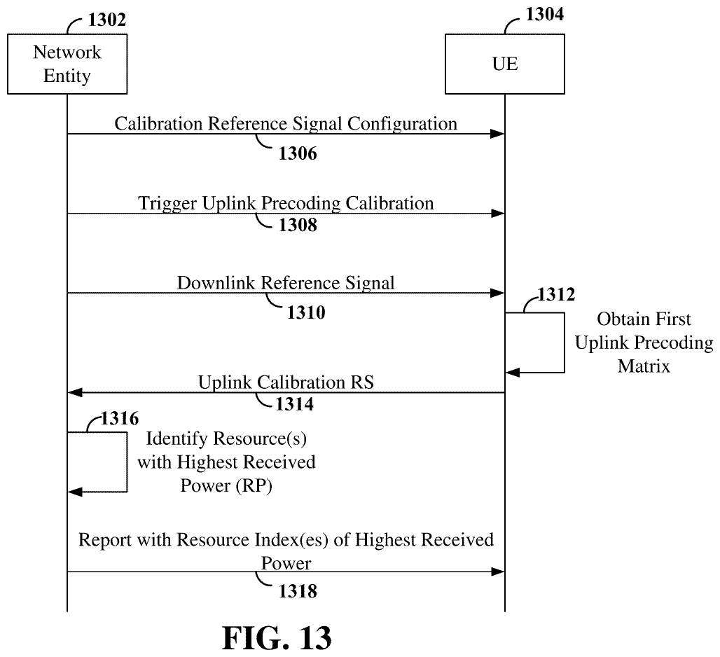

FIG. 13 is a signaling diagram illustrating other exemplary signaling between a network entity 1302 and a UE 1304 for acquiring a phase error compensation matrix for calibration of an uplink precoding matrix according to some aspects. The UE 1304 may correspond to any of the UEs or other wireless communication devices shown in any of FIGS. 1, 2, and/or 6. The network entity 1302 may correspond to any of the base stations or other network entities shown in FIGS. 1, 2 and/or 6. For example, the network entity 1302 may correspond to an aggregated base station, an RU, a DU, a CU, a TRP, an IAB node, or other network device.

At 1306, the network entity 1302 can provide a calibration reference signal configuration to the UE 1304. The calibration reference signal configuration may indicate, for example, the number of resources (L) for an uplink calibration reference signal and/or the number of sets (M−1) of calibration reference signal resources based on the capability of the UE 1304 provided at 1306. The calibration reference signal configuration may include, for example, an RRC configuration, MAC-CE configuration, and/or DCI configuration. The calibration reference signal configuration may further include the time/frequency location of the uplink calibration reference signal, a repetition factor of the uplink calibration reference signal, a frequency hopping parameter for the uplink calibration reference signal, a periodicity of transmission of the uplink calibration reference signal, report timing and/or resources for the network entity to report the best resource index or best-K resource indices, and/or other parameters related to the uplink calibration reference signal. In some examples, the transmission timing (e.g., in terms of period and offset) of the uplink calibration reference signal may be configured via RRC.

At 1308, the network entity 1302 can trigger uplink precoding calibration in accordance with the calibration reference signal configuration. For example, the network entity 1302 can trigger the UE 1304 to transmit an uplink calibration reference signal by providing an instruction to the UE 1304 to perform uplink precoding calibration via MAC-CE or DCI. In some examples, the instruction may include scheduling information to dynamically, semi-persistently, or periodically schedule the transmission of one or more of a downlink reference signal and/or an uplink calibration reference signal.

At 1310, the network entity 1302 may send a downlink reference signal, such as a CSI-RS, to the UE 1304. In some examples, the network entity 1302 may transmit a set of non-precoded CSI-RSs to the UE 1304. The UE 1304 may then measure the CSI-RS(s) to estimate channel state information based on, for example, the path loss, propagation delay, and received signal strength of the received CSI-RS. At 1312, the UE 1304 then obtains a first uplink precoding matrix for an uplink transmission based on the channel state information. The first uplink precoding matrix is non-codebook-based, which provides for higher resolution than codebook-based precoding.

At 1314, the UE 1304 transmits an uplink calibration reference signal (RS) with a plurality of resources (e.g., L resources), each precoded with a respective phase shift from the first uplink precoding matrix. For example, each of the L resources of the uplink calibration reference signal may be precoded with a respective second uplink precoding matrix having a respective phase shift from the first uplink precoding matrix.

At 1316, the network entity 1302 can measure the respective power (e.g., reference signal received power (RSRP)) of each of the L resources and identify the resource or resources having the highest received power. In some examples, the network entity 1302 identifies a single resource with the highest received power. In other examples, the network entity 1302 identifies the K resources out of the total L resources with the highest received powers, where L>K>1.

At 1318, the network entity 1302 sends a report to the UE 1304 including the resource index(es) identifying the resource(s) having the highest received power among the plurality of resources. In some examples, the network entity 1102 schedules the resources for sending the report via MAC-CE and/or DCI. In other examples, the resources for sending the report are configured via the calibration reference signal configuration.

The UE 1304 can then calibrate the first uplink precoding matrix based on the identified resources with the highest power to obtain a calibrated uplink precoding matrix as illustrated in FIG. 7. For example, the UE 1304 can identify a phase calibration error corresponding to the phase error compensation matrix E based on the respective phase shift(s) associated with the reported resource(s) having the highest power. The UE 1304 can then apply a phase error compensation matrix corresponding to the phase calibration error to the first uplink precoding matrix to produce the calibrated uplink precoding matrix. The UE 1304 may then use the calibrated uplink precoding matrix to transmit an uplink signal (e.g., an SRS or PUSCH) to the network entity 1302. For example, the UE 1304 may send a set of precoded SRSs to the network entity 1302 to obtain the MCS and then use the MCS to subsequently transmit a PUSCH as illustrated in FIG. 5.

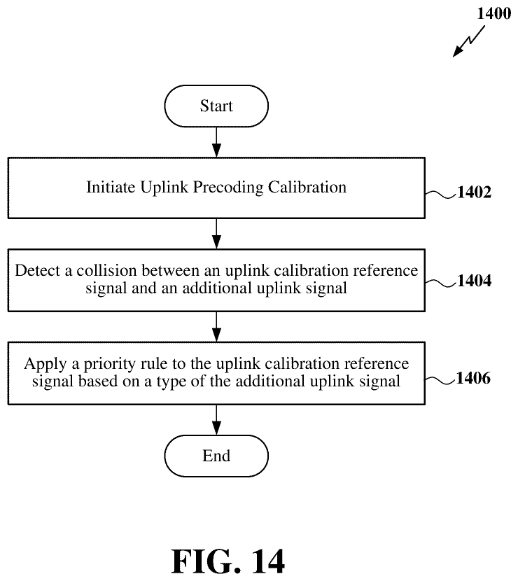

FIG. 14 is a flow chart illustrating an exemplary process 1400 for a UE to manage collisions with uplink calibration reference signals according to some aspects. As described below, some or all illustrated features may be omitted in a particular implementation within the scope of the present disclosure, and some illustrated features may not be required for implementation of all embodiments. In some examples, the process 1400 may be carried out by any of the UEs shown in FIGS. 1, 2, 4-6, 11-13, and/or 15. In some examples, the process 1400 may be carried out by any suitable apparatus or means for carrying out the functions or algorithm described below.

At block 1402, the UE can initiate uplink precoding calibration. In some examples, the UE can send a request for uplink precoding calibration to the network entity and receive a calibration reference signal configuration from the network entity. In other examples, the network entity can send a calibration reference signal configuration to the UE and trigger uplink precoding calibration. The UE can then measure a downlink reference signal (e.g., CSI-RS) to obtain an initial (first) uplink precoding matrix.

At block 1404, the UE can detect a collision between an uplink calibration reference signal scheduled (e.g., dynamically, semi-persistently, or periodically) for transmission by the UE to the network entity and an additional uplink signal. The additional uplink signal may be, for example, an SRS, PUCCH, PUSCH, DMRS, or other uplink signal.

At block 1406, the UE can apply a priority rule to the uplink calibration reference signal based on a type of the additional uplink signal. For example, the priority rule may prioritize the uplink calibration reference signal over SRS resources and PUCCH for channel state information (CSI). In this example, the SRS or PUCCH would be canceled to allow the UE to send the uplink calibration reference signal. As another example, the priority rule may prioritize PUCCH for ACK/NACK over the uplink calibration reference signal. In this example, the uplink calibration reference signal would be canceled to allow the UE to send the PUCCH with ACK/NACK. As yet another example, the priority rule may allow a PUSCH to be rate-matched around the uplink calibration reference signal to enable both the PUSCH and uplink calibration reference signal to be sent. As yet another example, the priority rule may prevent an uplink calibration reference signal from being mapped to DMRS symbols.

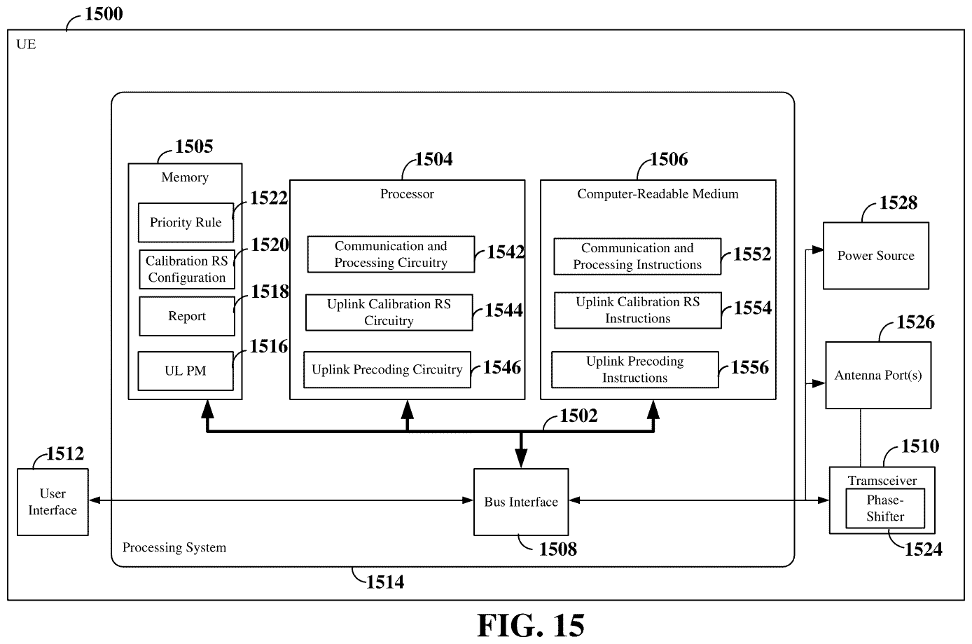

FIG. 15 is a block diagram illustrating an example of a hardware implementation of a user equipment (UE) 1500 employing a processing system 1514 according to some aspects. For example, the UE 1500 may correspond to any of the UEs shown and described above in reference to FIGS. 1, 2, 4-7, and/or 11-13.

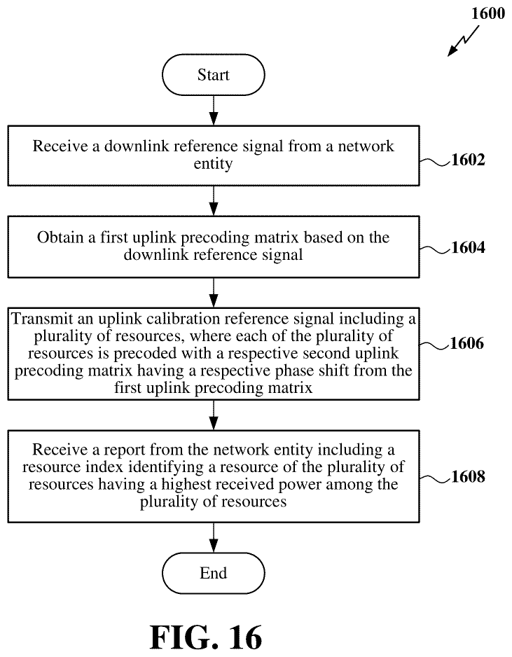

In accordance with various aspects of the disclosure, an element, or any portion of an element, or any combination of elements may be implemented with a processing system 1514 that includes one or more processors, such as processor 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1500 may be configured to perform any one or more of the functions described herein. That is, the processor 1504, as utilized in the UE 1500, may be used to implement any one or more of the methods or processes described and illustrated, for example, in FIGS. 14, 16, and/or 17.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits, including one or more processors (represented generally by the processor 1504), one or more memories (represented generally by the memory 1505), and one or more computer-readable media (represented generally by the computer-readable medium 1506). In some examples, the computer-readable media 1506 may be included within or part of one or more of the memories 1505. The bus 1502 may also link various other circuits such as timing sources, peripherals, voltage regulators, and power management circuits, which are well known in the art, and therefore, are not described any further.

A bus interface 1508 provides an interface between the bus 1502, one or more transceivers 1510, one or more antenna ports (e.g., antenna ports of one or more antenna arrays or panels) 1526, and a power source 1528 (e.g., a battery). The transceiver 1510 and antenna port(s) 1526 provides a means for communicating with various other apparatus over a transmission medium (e.g., air interface). The bus interface 1508 further provides an interface between the bus 1502 and a user interface 1512 (e.g., keypad, display, touch screen, speaker, microphone, control features, etc.). Of course, such a user interface 1512 may be omitted in some examples.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. In some examples, the computer-readable medium 1506 may be part of the memory 1505. Those skilled in the art will recognize how best to implement the described functionality presented throughout this disclosure depending on the particular application and the overall design constraints imposed on the overall system. In some examples, the computer-readable medium 1506 may be implemented on an article of manufacture, which may further include one or more other elements or circuits, such as the processor 1504 and/or memory 1505.

The computer-readable medium 1506 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1504, may be responsible for managing the bus 1502 and general processing, including the execution of the software (e.g., instructions or computer-executable code) stored on the computer-readable medium 1506. The software, when executed by the processor 1504, causes the processing system 1514 to perform the various processes and functions described herein for any particular apparatus. The computer-readable medium 1506 and/or the memory 1505 may also be used for storing data that may be manipulated by the processor 1504 when executing software. For example, the memory 1505 may store one or more uplink precoding matrices (PM) 1516 (e.g., an initial/first uplink precoding matrix, respective second uplink precoding matrices associated with the uplink calibration reference signal, and a calibrated uplink precoding matrix), a report 1518 containing the resource index(es) of the uplink calibration resources having the highest received power at a network entity, a calibration reference signal configuration 1520, and one or more priority rule(s) 1522.

In some aspects of the disclosure, the processor 1504 may include circuitry configured for various functions. For example, the processor 1504 may include communication and processing circuitry 1542 configured to communicate with one or more UEs and/or one or more network entities. In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1542 may include one or more transmit/receive chains.

In some implementations where the communication involves receiving information, the communication and processing circuitry 1542 may obtain information from a component of the UE 1500 (e.g., from the transceiver 1510 that receives the information via radio frequency signaling or some other type of signaling suitable for the applicable communication medium), process (e.g., decode) the information, and output the processed information. For example, the communication and processing circuitry 1542 may output the information to another component of the processor 1504, to the memory 1505, or to the bus interface 1508. In some examples, the communication and processing circuitry 1542 may receive one or more of signals, messages, other information, or any combination thereof. In some examples, the communication and processing circuitry 1542 may receive information via one or more channels. In some examples, the communication and processing circuitry 1542 may include functionality for a means for receiving. In some examples, the communication and processing circuitry 1542 may include functionality for a means for processing, including a means for demodulating, a means for decoding, etc.

In some implementations where the communication involves sending (e.g., transmitting) information, the communication and processing circuitry 1542 may obtain information (e.g., from another component of the processor 1504, the memory 1505, or the bus interface 1508), process (e.g., modulate, encode, etc.) the information, and output the processed information. For example, the communication and processing circuitry 1542 may output the information to the transceiver 1510 (e.g., that transmits the information via radio frequency signaling or some other type of signaling suitable for the applicable communication medium). In some examples, the communication and processing circuitry 1542 may send one or more of signals, messages, other information, or any combination thereof. In some examples, the communication and processing circuitry 1542 may send information via one or more channels. In some examples, the communication and processing circuitry 1542 may include functionality for a means for sending (e.g., a means for transmitting). In some examples, the communication and processing circuitry 1542 may include functionality for a means for generating, including a means for modulating, a means for encoding, etc.

In some examples, the communication and processing circuitry 1542 may be configured to receive and process downlink beamformed signals at a mmWave frequency or a sub-6 GHz frequency via the transceiver 1510 and the antenna port(s) 1526 (e.g., using a phase-shifter 1524). In addition, the communication and processing circuitry 1542 may be configured to generate and transmit uplink beamformed signals at a mmWave frequency or a sub-6 GHz frequency via the transceiver 1510 and antenna port(s) 1526 (e.g., using the phase-shifter 1524).

In some examples, the communication and processing circuitry 1542 may be configured to communicate with a network entity (e.g., aggregated or disaggregated base station gNB, TRP(s), etc.) to receive a downlink reference signal from the network entity. In some examples, the downlink reference signal may correspond to a CSI-RS. The communication and processing circuitry 1542 may further be configured to transmit an uplink calibration reference signal that includes plurality of resources. The communication and processing circuitry 1542 may further be configured to receive a report 1518 from the network entity. The report 1518 may include, for example, a resource index identifying a resource of the plurality of resources having a highest received power among the plurality of resources. In some examples, the report 1518 may include two or more resource indices, each identifying a respective resource of the plurality of resources having one of two or more highest received powers among the plurality of resources. The communication and processing circuitry 1542 may further be configured to store the report 1518 within, for example, the memory 1505.

The communication and processing circuitry 1542 may further be configured to receive a calibration reference signal configuration 1520 from the network entity. The calibration reference signal configuration 1520 includes, for example, at least one of a number of the plurality of resources, a time and frequency location of each of the plurality of resources, a repetition factor of the uplink calibration reference signal, a frequency hopping parameter of the uplink calibration reference signal, a periodicity of transmission of the uplink calibration reference signal, or report resources for the report 1518. In some examples, the calibration reference signal configuration 1520 further includes a number of two or more uplink calibration reference signals. The communication and processing circuitry 1542 may further be configured to store the calibration reference signal configuration 1520 within, for example, memory 1505.

The communication and processing circuitry 1542 may further be configured to transmit a capability of the UE to the network entity. The capability may indicate, for example, a number of the plurality of resources of the uplink calibration reference signal. In some examples, the communication and processing circuitry 1542 may be configured to transmit a request for uplink precoding calibration to the network entity. In some examples, the communication and processing circuitry 1542 may be configured to receive a request (e.g., trigger) for uplink precoding calibration from the network entity. The communication and processing circuitry 1542 may further be configured to execute communication and processing software 1552 stored on the computer-readable medium 1506 to implement one or more functions described herein.

The processor 1504 may further include uplink calibration reference signal circuitry 1544, configured to generate an uplink calibration reference signal for transmission to the network entity via the communication and processing circuitry 1542. The uplink calibration reference signal circuitry 1544 may be configured, for example, to obtain a first uplink precoding matrix 1516 based on the downlink reference signal received via the communication and processing circuitry 1542. The uplink calibration reference signal circuitry 1544 may further be configured to generate the uplink calibration reference signal including the plurality of resources and to instruct the communication and processing circuitry 1542 to transmit the uplink calibration reference signal. The uplink calibration reference signal circuitry 1544 may be configured to precode each of the plurality of resources of the uplink calibration reference signal with a respective second uplink precoding matrix 1516, each respective second uplink precoding matrix 1516 including a respective phase shift from the first uplink precoding matrix. Thus, the uplink calibration reference signal circuitry 1544 is configured to identify each of the respective second uplink precoding matrices 1516 and to precode each of the plurality of resources of the uplink calibration reference signal with a respective one of the second uplink precoding matrices 1516. In some examples, the plurality of resources are contiguous in at least one of time or frequency.

In some examples, the first uplink precoding matrix 1516 includes a first vector of precoding values, where each element of the first vector is associated with an antenna port of a plurality of antenna ports 1526 of the UE. In this example, each of the respective second uplink precoding matrices 1516 includes a respective second vector of precoding values. Each element of each of the respective second vectors includes a respective phase shift from a corresponding element of the first vector, where the respective phase shift is equal across the respective elements of a given second vector. In some examples, a first number of the plurality of resources is based on a second number of the plurality of antenna ports 1526. In some examples, each of the plurality of resources spans at least one of a respective set of two or more time resources or a respective set of two or more frequency resources.

In some examples, the uplink calibration reference signal includes a set of two or more uplink calibration reference signals, each associated with a respective set of two antenna ports of a plurality of antenna ports 1526 at the UE. In this example, each of the respective sets of two antenna ports includes a first antenna port of the plurality of antenna ports 1526 and a different respective remaining antenna port of the plurality of antenna ports 1526. In some examples, the first uplink precoding matrix 1516 includes a vector of precoding values. Each element of the vector is associated with a respective antenna port of the plurality of antenna ports 1526. In addition, each of the respective second uplink precoding matrices 1516 associated with a given uplink calibration reference signal of the two or more uplink calibration reference signals is associated with a same set of two respective elements of the vector corresponding to the respective set of two antenna ports for the given uplink calibration reference signal. In some examples, the report 1518 includes a respective resource index for each of the two or more uplink calibration reference signals. In some examples, the respective plurality of resources across the two or more uplink calibration reference signals are contiguous in at least one of time or frequency.

In some examples, each of the respective phase shifts from the first uplink precoding matrix for the plurality of resources are quantized within a first range (of phase shifts). The uplink calibration reference signal circuitry 1544 may further be configured to generate a second uplink calibration reference signal including a plurality of additional resources. Each of the plurality of additional resources is precoded based on a respective second phase shift from the first uplink precoding matrix quantized within a second range, where the second range is a subset of the first range. The uplink calibration reference signal circuitry 1544 may further be configured to instruct the communication and processing circuitry 1542 to transmit the second uplink calibration reference signal to the network entity and to receive a second report 1518 from the network entity including a second resource index identifying a second resource of the plurality of additional resources having an additional highest received power.

In some examples, the uplink calibration reference signal circuitry 1544 may further be configured to detect a collision between the uplink calibration reference signal and an additional uplink signal. The uplink calibration reference signal circuitry 1544 may further be configured to apply a priority rule 1522 (e.g., maintained in memory 1505) to the uplink calibration reference signal based on a type of the additional uplink signal.

The uplink calibration reference signal circuitry 1544 is further configured to identify a phase calibration error based on the respective phase shift associated with the resource having the highest received power. The uplink calibration reference signal circuitry 1544 is further configured to apply a phase error compensation matrix corresponding to the phase calibration error to the first uplink precoding matrix 1516 to produce a calibrated uplink precoding matrix 1516. The uplink calibration reference signal circuitry 1544 may further be configured to execute uplink calibration reference signal instructions (software) 1554 stored on the computer-readable medium 1506 to implement one or more functions described herein.

The processor 1504 may further include uplink precoding circuitry 1546, configured to generate an uplink signal for transmission by the communication and processing circuitry 1542 to the network entity. The uplink precoding circuitry 1546 may be configured to precode the uplink signal with the calibrated uplink precoding matrix 1516 for transmission to the network entity. The uplink precoding circuitry 1546 may further be configured to execute uplink precoding instructions (software) 1556 stored on the computer-readable medium 1506 to implement one or more functions described herein.

FIG. 16 is a flow chart illustrating an exemplary process 1600 for uplink precoding calibration according to some aspects. As described below, some or all illustrated features may be omitted in a particular implementation within the scope of the present disclosure, and some illustrated features may not be required for implementation of all embodiments. In some examples, the process 1600 may be carried out by the UE 1500 illustrated in FIG. 15. In some examples, the process 1600 may be carried out by any suitable apparatus or means for carrying out the functions or algorithm described below.

At block 1602, the UE may receive a downlink reference signal from a network entity. For example, the uplink calibration reference signal circuitry 1544, together with the communication and processing circuitry 1542, transceiver 1510, and antenna port(s) 1526 shown and described above in connection with FIG. 15, may provide a means to receive the downlink reference signal.

At block 1604, the UE may obtain a first uplink precoding matrix based on the downlink reference signal. For example, the uplink calibration reference signal circuitry 1544, shown and described above in connection with FIG. 15, may provide a means to obtain the first uplink precoding matrix.

At block 1606, the UE may transmit an uplink calibration reference signal including a plurality of resources, where each of the plurality of resources is precoded with a respective second uplink precoding matrix having a respective phase shift from the first uplink precoding matrix. In some examples, the plurality of resources are contiguous in at least one of time or frequency. For example, the uplink calibration reference signal circuitry 1544, together with the communication and processing circuitry 1542, transceiver 1510, and antenna port(s) 1526 shown and described above in connection with FIG. 15, may provide a means to transmit the uplink calibration reference signal.

In some examples, the first uplink precoding matrix includes a first vector of precoding values, where each element of the first vector is associated with an antenna port of a plurality of antenna ports of the UE. In this example, each of the respective second uplink precoding matrices includes a respective second vector of precoding values, where each element of each of the respective second vectors has a respective phase shift from a corresponding element of the first vector and the respective phase shift is equal across the respective elements of a given second vector. In some examples, a first number of the plurality of resources is based on a second number of the plurality of antenna ports. In some examples, each of the plurality of resources spans at least one of a respective set of two or more time resources or a respective set of two or more frequency resources.

In some examples, the uplink calibration reference signal includes a set of two or more uplink calibration reference signals, each associated with a respective set of two antenna ports of a plurality of antenna ports at the UE. Each of the respective sets of two antenna ports includes a first antenna port of the plurality of antenna ports and a different respective remaining antenna port of the plurality of antenna ports. In this example, the first uplink precoding matrix includes a vector of precoding values, where each element of the vector is associated with a respective antenna port of the plurality of antenna ports. In addition, each of the respective second uplink precoding matrices associated with a given uplink calibration reference signal of the two or more uplink calibration reference signals is associated with a same set of two respective elements of the vector corresponding to the respective set of two antenna ports for the given uplink calibration reference signal. In some examples, the UE may further receive a calibration reference signal configuration from the network entity, where the calibration reference signal configuration includes a number of the two or more uplink calibration reference signals. In some examples, the respective plurality of resources across the two or more uplink calibration reference signals are contiguous in at least one of time or frequency.

In some examples, the UE may further transmit a capability of the UE to the network entity, where the capability indicates a number of the plurality of resources. In some examples, the UE may transmit the uplink calibration reference signal in response to a request for uplink precoding calibration by the network entity or the UE. In some examples, the UE may detect a collision between the uplink calibration reference signal and an additional uplink signal and apply a priority rule to the uplink calibration reference signal based on a type of the additional uplink signal.

At block 1608, the UE may receive a report from the network entity, where the report includes a resource index identifying a resource of the plurality of resources having a highest received power among the plurality of resources. In some examples, the report includes two or more resource indices, each identifying a respective resource of the plurality of resources having one of two or more highest received powers among the plurality of resources. In some examples, the report includes a respective resource index for each of the two or more uplink calibration reference signals. For example, the uplink calibration reference signal circuitry 1544, together with the communication and processing circuitry 1542, transceiver 1510, and antenna port(s) 1526 shown and described above in connection with FIG. 15, may provide a means to receive the report.

In some examples, the UE may further receive a calibration reference signal configuration from the network entity. The calibration reference signal configuration can include at least one of a number of the plurality of resources, a time and frequency location of each of the plurality of resources, a repetition factor of the uplink calibration reference signal, a frequency hopping parameter of the uplink calibration reference signal, a periodicity of transmission of the uplink calibration reference signal, or report resources for the report.

In some examples, each of the respective phase shifts from the first uplink precoding matrix for the plurality of resources are quantized within a first range. In this example, the UE may further transmit a second uplink calibration reference signal including a plurality of additional resources, where each of the plurality of additional resources is precoded based on a respective second phase shift from the first uplink precoding matrix quantized within a second range and the second range is a subset of the first range. In addition, the UE may receive a second report from the network entity including a second resource index identifying a second resource of the plurality of additional resources having an additional highest received power.

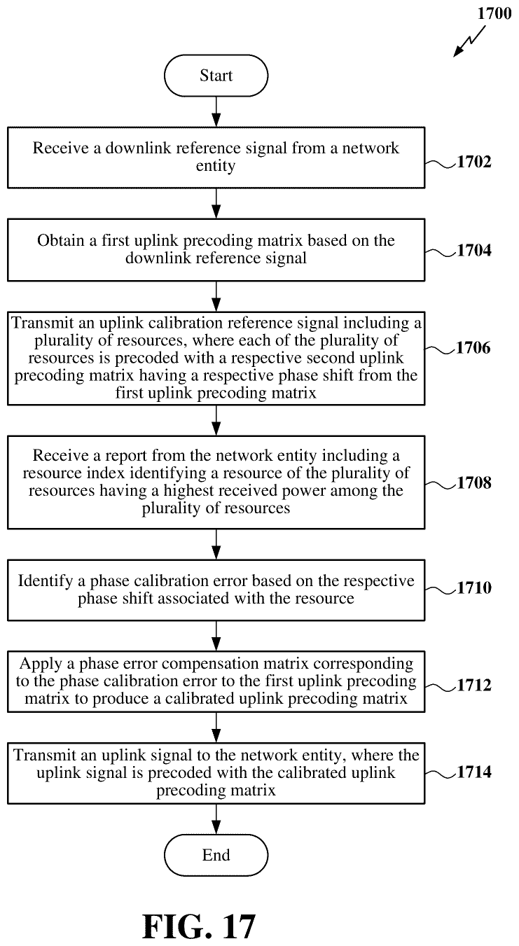

FIG. 17 is a flow chart illustrating another exemplary process 1700 for uplink precoding calibration according to some aspects. As described below, some or all illustrated features may be omitted in a particular implementation within the scope of the present disclosure, and some illustrated features may not be required for implementation of all embodiments. In some examples, the process 1700 may be carried out by the UE 1500 illustrated in FIG. 15. In some examples, the process 1700 may be carried out by any suitable apparatus or means for carrying out the functions or algorithm described below.

At block 1702, the UE may receive a downlink reference signal from a network entity. For example, the uplink calibration reference signal circuitry 1544, together with the communication and processing circuitry 1542, transceiver 1510, and antenna port(s) 1526 shown and described above in connection with FIG. 15, may provide a means to receive the downlink reference signal.

At block 1704, the UE may obtain a first uplink precoding matrix based on the downlink reference signal. For example, the uplink calibration reference signal circuitry 1544, shown and described above in connection with FIG. 15, may provide a means to obtain the first uplink precoding matrix.

At block 1706, the UE may transmit an uplink calibration reference signal including a plurality of resources, where each of the plurality of resources is precoded with a respective second uplink precoding matrix having a respective phase shift from the first uplink precoding matrix. In some examples, the plurality of resources are contiguous in at least one of time or frequency. For example, the uplink calibration reference signal circuitry 1544, together with the communication and processing circuitry 1542, transceiver 1510, and antenna port(s) 1526 shown and described above in connection with FIG. 15, may provide a means to transmit the uplink calibration reference signal.

In some examples, the first uplink precoding matrix includes a first vector of precoding values, where each element of the first vector is associated with an antenna port of a plurality of antenna ports of the UE. In this example, each of the respective second uplink precoding matrices includes a respective second vector of precoding values, where each element of each of the respective second vectors has a respective phase shift from a corresponding element of the first vector and the respective phase shift is equal across the respective elements of a given second vector. In some examples, a first number of the plurality of resources is based on a second number of the plurality of antenna ports. In some examples, each of the plurality of resources spans at least one of a respective set of two or more time resources or a respective set of two or more frequency resources.

In some examples, the uplink calibration reference signal includes a set of two or more uplink calibration reference signals, each associated with a respective set of two antenna ports of a plurality of antenna ports at the UE. Each of the respective sets of two antenna ports includes a first antenna port of the plurality of antenna ports and a different respective remaining antenna port of the plurality of antenna ports. In this example, the first uplink precoding matrix includes a vector of precoding values, where each element of the vector is associated with a respective antenna port of the plurality of antenna ports. In addition, each of the respective second uplink precoding matrices associated with a given uplink calibration reference signal of the two or more uplink calibration reference signals is associated with a same set of two respective elements of the vector corresponding to the respective set of two antenna ports for the given uplink calibration reference signal. In some examples, the UE may further receive a calibration reference signal configuration from the network entity, where the calibration reference signal configuration includes a number of the two or more uplink calibration reference signals. In some examples, the respective plurality of resources across the two or more uplink calibration reference signals are contiguous in at least one of time or frequency.

In some examples, the UE may further transmit a capability of the UE to the network entity, where the capability indicates a number of the plurality of resources. In some examples, the UE may transmit the uplink calibration reference signal in response to a request for uplink precoding calibration by the network entity or the UE. In some examples, the UE may detect a collision between the uplink calibration reference signal and an additional uplink signal and apply a priority rule to the uplink calibration reference signal based on a type of the additional uplink signal.

At block 1708, the UE may receive a report from the network entity, where the report includes a resource index identifying a resource of the plurality of resources having a highest received power among the plurality of resources. In some examples, the report includes two or more resource indices, each identifying a respective resource of the plurality of resources having one of two or more highest received powers among the plurality of resources. In some examples, the report includes a respective resource index for each of the two or more uplink calibration reference signals. For example, the uplink calibration reference signal circuitry 1544, together with the communication and processing circuitry 1542, transceiver 1510, and antenna port(s) 1526 shown and described above in connection with FIG. 15, may provide a means to receive the report.

In some examples, the UE may further receive a calibration reference signal configuration from the network entity. The calibration reference signal configuration can include at least one of a number of the plurality of resources, a time and frequency location of each of the plurality of resources, a repetition factor of the uplink calibration reference signal, a frequency hopping parameter of the uplink calibration reference signal, a periodicity of transmission of the uplink calibration reference signal, or report resources for the report.

In some examples, each of the respective phase shifts from the first uplink precoding matrix for the plurality of resources are quantized within a first range. In this example, the UE may further transmit a second uplink calibration reference signal including a plurality of additional resources, where each of the plurality of additional resources is precoded based on a respective second phase shift from the first uplink precoding matrix quantized within a second range and the second range is a subset of the first range. In addition, the UE may receive a second report from the network entity including a second resource index identifying a second resource of the plurality of additional resources having an additional highest received power.

At block 1710, the UE may identify a phase calibration error based on the respective phase shift associated with the resource. For example, the uplink calibration reference signal circuitry 1544, shown and described above in connection with FIG. 15, may provide a means to identify the phase calibration error.

At block 1712, the UE may apply a phase error compensation matrix corresponding to the phase calibration error to the first uplink precoding matrix to produce a calibrated uplink precoding matrix. For example, the uplink calibration reference signal circuitry 1544, shown and described above in connection with FIG. 15, may provide a means to produce the calibrated uplink precoding matrix.

At block 1714, the UE may transmit an uplink signal to the network entity, where the uplink signal is precoded with the calibrated uplink precoding matrix. The uplink signal may correspond, for example, to a PUCCH, PUSCH, uplink reference signal, or other suitable uplink signal. For example, the uplink precoding circuitry 1546, together with the communication and processing circuitry 1542, transceiver 1510, and antenna port(s) 1526 shown and described above in connection with FIG. 15, may provide a means to transmit the uplink signal.

In one configuration, the UE includes means for receiving a downlink reference signal from a network entity, means for obtaining a first uplink precoding matrix based on the downlink reference signal, means for transmitting an uplink calibration reference signal comprising a plurality of resources, wherein each of the plurality of resources is precoded with a respective second uplink precoding matrix comprising a respective phase shift from the first uplink precoding matrix, and means for receiving a report from the network entity, wherein the report comprises a resource index identifying a resource of the plurality of resources having a highest received power among the plurality of resources. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 2, 4-7, 11-13 and/or 15, and utilizing, for example, the processes and/or algorithms described herein in relation to FIGS. 14, 16, and 17.

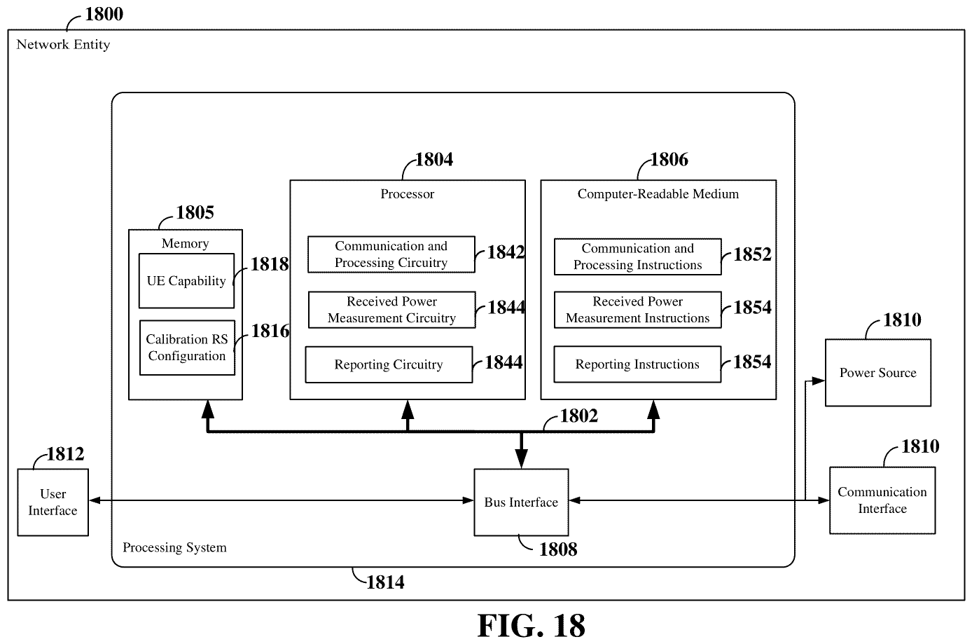

FIG. 18 is a block diagram illustrating an example of a hardware implementation of a network entity 1800 employing a processing system 1814 according to some aspects. The network entity 1800 may be, for example, a network entity or other network node illustrated in any one or more of FIGS. 1, 2, 4-7, and/or 11-13. For example, the network entity may be a base station (e.g., gNB, eNB) or other scheduling entity as illustrated in any one or more of FIGS. 1 and/or 2. A network entity may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, a network entity may be a stationary network entity or a mobile network entity.

In accordance with various aspects of the disclosure, an element, or any portion of an element, or any combination of elements may be implemented with a processing system 1814 that includes one or more processors, such as processor 1804. The processing system 1814 may be substantially the same as the processing system 1514 as shown and described above in connection with FIG. 15, including a bus interface 1808, a bus 1802, a memory 1805 (e.g., one or more memories), a processor 1804 (e.g., one or more processors), and a computer-readable medium 1806 (e.g., one or more computer-readable mediums). Accordingly, their descriptions will not be repeated for the sake of brevity. Furthermore, the network entity 1800 may include an optional user interface 1812 and a communication interface 1810 (e.g., wired or wireless), such as one or more transceivers or one or more network interfaces.

The processor 1804, as utilized in the network entity 1800, may be used to implement any one or more of the processes described below. In some examples, the memory 1805 may store one or more of a calibration reference signal configuration 1816 and/or a UE capability 1818.

In some aspects of the disclosure, the processor 1804 may include communication and processing circuitry 1842 configured for various functions, including, for example, communicating with one or more wireless communication devices (e.g., UEs), a core network node, or other network entity. In some examples (e.g., in an aggregated base station architecture), the communication and processing circuitry 1842 may include one or more hardware components that provide the physical structure that performs processes related to wireless communication (e.g., signal reception and/or signal transmission) and/or signal processing (e.g., processing a received signal and/or processing a signal for transmission). In addition, the communication and processing circuitry 1842 may be configured to process and transmit downlink traffic and downlink control and receive and process uplink traffic and uplink control.

In some examples, the communication and processing circuitry 1842 may be configured to communicate with a UE to provide a downlink reference signal for the UE. In some examples, the downlink reference signal may correspond to a CSI-RS. The communication and processing circuitry 1842 may further be configured to obtain an uplink calibration reference signal that includes plurality of resources from the UE. In some examples, each of the plurality of resources is precoded with a respective second uplink precoding matrix having a respective phase shift from a first uplink precoding matrix obtained based on the downlink reference signal. In some examples, the plurality of resources are contiguous in at least one of time or frequency. The communication and processing circuitry 1842 may further be configured to provide a report for the UE.

In some examples, the first uplink precoding matrix includes a first vector of precoding values, where each element of the first vector is associated with an antenna port of a plurality of antenna ports of the UE. In this example, each of the respective second uplink precoding matrices includes a respective second vector of precoding values. Each element of each of the respective second vectors includes a respective phase shift from a corresponding element of the first vector, where the respective phase shift is equal across the respective elements of a given second vector. In some examples, a first number of the plurality of resources is based on a second number of the plurality of antenna ports. In some examples, each of the plurality of resources spans at least one of a respective set of two or more time resources or a respective set of two or more frequency resources.

In some examples, the uplink calibration reference signal includes a set of two or more uplink calibration reference signals, each associated with a respective set of two antenna ports of a plurality of antenna ports at the UE. In this example, each of the respective sets of two antenna ports includes a first antenna port of the plurality of antenna ports and a different respective remaining antenna port of the plurality of antenna ports. In some examples, the first uplink precoding matrix includes a vector of precoding values. Each element of the vector is associated with a respective antenna port of the plurality of antenna ports. In addition, each of the respective second uplink precoding matrices associated with a given uplink calibration reference signal of the two or more uplink calibration reference signals is associated with a same set of two respective elements of the vector corresponding to the respective set of two antenna ports for the given uplink calibration reference signal. In some examples, the respective plurality of resources across the two or more uplink calibration reference signals are contiguous in at least one of time or frequency.

In some examples, each of the respective phase shifts from the first uplink precoding matrix for the plurality of resources are quantized within a first range (of phase shifts). The communication and processing circuitry 1842 may further be configured to obtain a second uplink calibration reference signal including a plurality of additional resources. Each of the plurality of additional resources is precoded based on a respective second phase shift from the first uplink precoding matrix quantized within a second range, where the second range is a subset of the first range. The communication and processing circuitry 1842 may further be configured to provide a second report including a second resource index identifying a second resource of the plurality of additional resources having an additional highest received power.

The communication and processing circuitry 1842 may further be configured to provide a calibration reference signal configuration 1816 for the UE. The calibration reference signal configuration 1816 includes, for example, at least one of a number of the plurality of resources, a time and frequency location of each of the plurality of resources, a repetition factor of the uplink calibration reference signal, a frequency hopping parameter of the uplink calibration reference signal, a periodicity of transmission of the uplink calibration reference signal, or report resources for the report. In some examples, the calibration reference signal configuration 1816 further includes a number of two or more uplink calibration reference signals.

The communication and processing circuitry 1842 may further be configured to obtain a capability 1818 of the UE. The capability 1818 may indicate, for example, a number of the plurality of resources of the uplink calibration reference signal. In some examples, the communication and processing circuitry 1842 may be configured to obtain a request for uplink precoding calibration for the UE. In some examples, the communication and processing circuitry 1842 may be configured to provide a request (e.g., trigger) for uplink precoding calibration for the UE.

The communication and processing circuitry 1842 may further be configured to obtain an uplink signal precoded with a calibrated uplink precoding matrix obtained based on the report. The communication and processing circuitry 1842 may further be configured to execute communication and processing software 1852 stored on the computer-readable medium 1806 to implement one or more functions described herein.

The processor 1804 may further include received power measurement circuitry 1844, configured to measure a respective received power of each resource of the plurality of resources of the uplink calibration reference signal. In some examples, the received power measurement circuitry 1844 may be configured to measure a respective received power of each of the plurality of resources of each of two or more uplink calibration reference signals.

The processor 1804 may further include reporting circuitry 1846, configured to generate a report for transmission by the communication and processing circuitry 1842 for the UE. The report may include, for example, a resource index identifying a resource of the plurality of resources having a highest received power among the plurality of resources. In some examples, the report may include two or more resource indices, each identifying a respective resource of the plurality of resources having one of two or more highest received powers among the plurality of resources. In some examples, the report includes a respective resource index for each of the two or more uplink calibration reference signals. The reporting circuitry 1846 may further be configured to execute reporting instructions (software) 1856 stored on the computer-readable medium 1806 to implement one or more functions described herein.

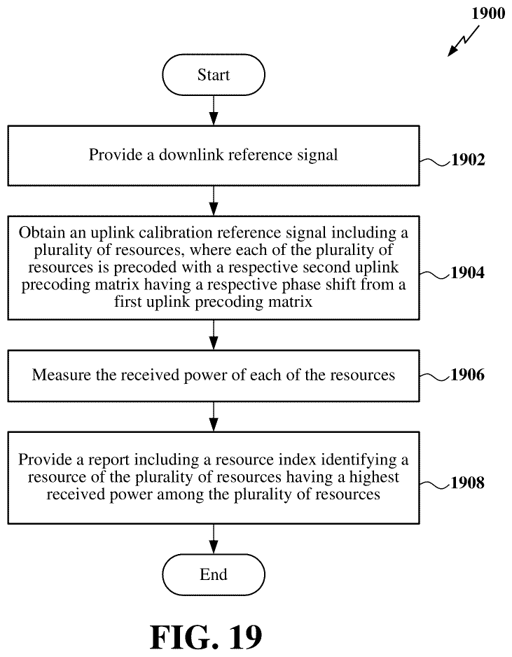

FIG. 19 is a flow chart illustrating another exemplary process 1900 for uplink precoding calibration according to some aspects. As described below, some or all illustrated features may be omitted in a particular implementation within the scope of the present disclosure, and some illustrated features may not be required for implementation of all embodiments. In some examples, the process 1900 may be carried out by the network entity 1800 illustrated in FIG. 18. In some examples, the process 1900 may be carried out by any suitable apparatus or means for carrying out the functions or algorithm described below.

At block 1902, the network entity may provide a downlink reference signal for a UE. For example, the communication and processing circuitry 1842, together with the communication interface 1810, shown and described above in connection with FIG. 18, may provide a means to provide the downlink reference signal.

At block 1904, the network entity may obtain an uplink calibration reference signal including a plurality of resources, where each of the plurality of resources is precoded with a respective second uplink precoding matrix having a respective phase shift from a first uplink precoding matrix. In some examples, the first precoding matrix is obtained based on the downlink reference signal. In some examples, the plurality of resources are contiguous in at least one of time or frequency. For example, the communication and processing circuitry 1842, together with the communication interface 1810, shown and described above in connection with FIG. 18, may provide a means to obtain the uplink calibration reference signal.

In some examples, the first uplink precoding matrix includes a first vector of precoding values, where each element of the first vector is associated with an antenna port of a plurality of antenna ports of the UE. In this example, each of the respective second uplink precoding matrices includes a respective second vector of precoding values, where each element of each of the respective second vectors has a respective phase shift from a corresponding element of the first vector and the respective phase shift is equal across the respective elements of a given second vector. In some examples, a first number of the plurality of resources is based on a second number of the plurality of antenna ports. In some examples, each of the plurality of resources spans at least one of a respective set of two or more time resources or a respective set of two or more frequency resources.

In some examples, the uplink calibration reference signal includes a set of two or more uplink calibration reference signals, each associated with a respective set of two antenna ports of a plurality of antenna ports at the UE. Each of the respective sets of two antenna ports includes a first antenna port of the plurality of antenna ports and a different respective remaining antenna port of the plurality of antenna ports. In this example, the first uplink precoding matrix includes a vector of precoding values, where each element of the vector is associated with a respective antenna port of the plurality of antenna ports. In addition, each of the respective second uplink precoding matrices associated with a given uplink calibration reference signal of the two or more uplink calibration reference signals is associated with a same set of two respective elements of the vector corresponding to the respective set of two antenna ports for the given uplink calibration reference signal. In some examples, the network entity may further provide a calibration reference signal configuration for the UE, where the calibration reference signal configuration includes a number of the two or more uplink calibration reference signals. In some examples, the respective plurality of resources across the two or more uplink calibration reference signals are contiguous in at least one of time or frequency.

In some examples, the network entity may further obtain a capability of the UE, where the capability indicates a number of the plurality of resources. In some examples, the network entity may obtain the uplink calibration reference signal in response to a request for uplink precoding calibration by the network entity or the UE.

At block 1906, the network entity may measure the power (e.g., received power) of each of the plurality of resources of the uplink calibration reference signal. For example, the received power measurement circuitry 1844, shown and described above in connection with FIG. 18, may provide a means to measure the power.

At block 1908, the network entity may provide a report including a resource index identifying a resource of the plurality of resources having a highest received power among the plurality of resources. In some examples, the report includes two or more resource indices, each identifying a respective resource of the plurality of resources having one of two or more highest received powers among the plurality of resources. In some examples, the report includes a respective resource index for each of the two or more uplink calibration reference signals. For example, the reporting circuitry 1846, together with the communication and processing circuitry 1842 and communication interface 1810, shown and described above in connection with FIG. 18, may provide a means to receive the report.

In some examples, the network entity may further provide a calibration reference signal configuration for the UE. The calibration reference signal configuration can include at least one of a number of the plurality of resources, a time and frequency location of each of the plurality of resources, a repetition factor of the uplink calibration reference signal, a frequency hopping parameter of the uplink calibration reference signal, a periodicity of transmission of the uplink calibration reference signal, or report resources for the report.

In some examples, each of the respective phase shifts from the first uplink precoding matrix for the plurality of resources are quantized within a first range. In this example, the network entity may further obtain a second uplink calibration reference signal including a plurality of additional resources, where each of the plurality of additional resources is precoded based on a respective second phase shift from the first uplink precoding matrix quantized within a second range and the second range is a subset of the first range. In addition, the network entity may provide a second report including a second resource index identifying a second resource of the plurality of additional resources having an additional highest received power.

In one configuration, the network entity includes means for providing a downlink reference signal, means for obtaining an uplink calibration reference signal including a plurality of resources, wherein each of the plurality of resources is precoded with a respective second uplink precoding matrix including a respective phase shift from a first uplink precoding matrix, means for measuring the received power of each of the plurality of resources, and means for providing a report including a resource index identifying a resource of the plurality of resources having a highest received power among the plurality of resources. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1, 4-7, 11-13 and/or 18, and utilizing, for example, the processes and/or algorithms described herein in relation to FIG. 19.

The following provides an overview of aspects of the present disclosure:

Aspect 1: A method operable at a user equipment (UE), the method comprising: receiving a downlink reference signal from a network entity; obtaining a first uplink precoding matrix based on the downlink reference signal; transmitting an uplink calibration reference signal comprising a plurality of resources, wherein each of the plurality of resources is precoded with a respective second uplink precoding matrix comprising a respective phase shift from the first uplink precoding matrix; and receiving a report from the network entity, wherein the report comprises a resource index identifying a resource of the plurality of resources having a highest received power among the plurality of resources.

Aspect 2: The method of aspect 1, further comprising: identifying a phase calibration error based on the respective phase shift associated with the resource; applying a phase error compensation matrix corresponding to the phase calibration error to the first uplink precoding matrix to produce a calibrated uplink precoding matrix; and transmitting an uplink signal to the network entity, wherein the uplink signal is precoded with the calibrated uplink precoding matrix.

Aspect 3: The method of aspect 1 or 2, wherein each of the respective phase shifts from the first uplink precoding matrix for the plurality of resources are quantized within a first range, and further comprising: transmitting a second uplink calibration reference signal comprising a plurality of additional resources, wherein each of the plurality of additional resources is precoded based on a respective second phase shift from the first uplink precoding matrix quantized within a second range, wherein the second range is a subset of the first range; and receiving a second report from the network entity comprising a second resource index identifying a second resource of the plurality of additional resources having an additional highest received power.

Aspect 4: The method of any of aspects 1 through 3, further comprising: receiving a calibration reference signal configuration from the network entity, wherein the calibration reference signal configuration comprises at least one of a number of the plurality of resources, a time and frequency location of each of the plurality of resources, a repetition factor of the uplink calibration reference signal, a frequency hopping parameter of the uplink calibration reference signal, a periodicity of transmission of the uplink calibration reference signal, or report resources for the report.

Aspect 5: The method of any of aspects 1 through 4, wherein the plurality of resources are contiguous in at least one of time or frequency.

Aspect 6: The method of any of aspects 1 through 5, wherein the report comprises two or more resource indices, each identifying a respective resource of the plurality of resources having one of two or more highest received powers among the plurality of resources.

Aspect 7: The method of any of aspects 1 through 6, wherein: the first uplink precoding matrix comprises a first vector of precoding values, wherein each element of the first vector is associated with an antenna port of a plurality of antenna ports of the UE, and each of the respective second uplink precoding matrices comprises a respective second vector of precoding values, wherein each element of each of the respective second vectors comprises a respective phase shift from a corresponding element of the first vector, wherein the respective phase shift is equal across the respective elements of a given second vector.

Aspect 8: The method of aspect 7, wherein a first number of the plurality of resources is based on a second number of the plurality of antenna ports.

Aspect 9: The method of aspect 7 or 8, wherein each of the plurality of resources spans at least one of a respective set of two or more time resources or a respective set of two or more frequency resources.

Aspect 10: The method of any of aspects 1 through 6, wherein the uplink calibration reference signal comprises a set of two or more uplink calibration reference signals, each associated with a respective set of two antenna ports of a plurality of antenna ports at the UE, wherein each of the respective sets of two antenna ports comprises a first antenna port of the plurality of antenna ports and a different respective remaining antenna port of the plurality of antenna ports.

Aspect 11: The method of aspect 10, wherein: the first uplink precoding matrix comprises a vector of precoding values, wherein each element of the vector is associated with a respective antenna port of the plurality of antenna ports, and each of the respective second uplink precoding matrices associated with a given uplink calibration reference signal of the two or more uplink calibration reference signals is associated with a same set of two respective elements of the vector corresponding to the respective set of two antenna ports for the given uplink calibration reference signal.

Aspect 12: The method of aspect 10 or 11, wherein the report comprises a respective resource index for each of the two or more uplink calibration reference signals.

Aspect 13: The method of any of aspects 10 through 12, further comprising: receiving a calibration reference signal configuration from the network entity, wherein the calibration reference signal configuration comprises a number of the two or more uplink calibration reference signals.

Aspect 14: The method of any of aspects 10 through 13, wherein the respective plurality of resources across the two or more uplink calibration reference signals are contiguous in at least one of time or frequency.

Aspect 15: The method of any of aspects 1 through 14, further comprising: transmitting a capability of the UE to the network entity, wherein the capability indicates a number of the plurality of resources.

Aspect 16: The method of any of aspects 1 through 15, wherein the transmitting the uplink calibration reference signal comprises: transmitting the uplink calibration reference signal in response to a request for uplink precoding calibration by the network entity or the UE.

Aspect 17: The method of any of aspects 1 through 16, further comprising: detecting a collision between the uplink calibration reference signal and an additional uplink signal; and applying a priority rule to the uplink calibration reference signal based on a type of the additional uplink signal.

Aspect 18: An apparatus at a user equipment (UE) comprising one or more memories and one or more processors coupled to the one or more memories, wherein the one or more processors are configured to cause the UE to perform a method of any of aspects 1 through 17.

Aspect 19: An apparatus at a UE comprising means for performing a method of any of aspects 1 through 17.

Aspect 20: A non-transitory computer-readable medium having stored therein instructions executable by one or more processors of a UE to cause the UE to perform a method of any of aspects 1 through 17.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 7, 8-10, and/or 12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

What is claimed is:

1. A user equipment (UE), comprising:
one or more memories; and
one or more processors coupled to the one or more memories, wherein the one or processors are configured to cause the UE to:
receive a downlink reference signal from a network entity;
obtain a first uplink precoding matrix based on the downlink reference signal;
transmit an uplink calibration reference signal comprising a plurality of resources, wherein each of the plurality of resources is precoded with a respective second uplink precoding matrix comprising a respective phase shift from the first uplink precoding matrix; and
receive a report from the network entity, wherein the report comprises a resource index identifying a resource of the plurality of resources having a highest received power among the plurality of resources.

2. The UE of claim 1, wherein the one or more processors are configured to cause the UE to:
identify a phase calibration error based on the respective phase shift associated with the resource;
apply a phase error compensation matrix corresponding to the phase calibration error to the first uplink precoding matrix to produce a calibrated uplink precoding matrix; and
transmit an uplink signal to the network entity, wherein the uplink signal is precoded with the calibrated uplink precoding matrix.

3. The UE of claim 2, wherein each of the respective phase shifts from the first uplink precoding matrix for the plurality of resources are quantized within a first range, and wherein the one or more processors are configured to cause the UE to:
transmit a second uplink calibration reference signal comprising a plurality of additional resources, wherein each of the plurality of additional resources is precoded based on a respective second phase shift from the first uplink precoding matrix quantized within a second range, wherein the second range is a subset of the first range; and
receive a second report from the network entity comprising a second resource index identifying a second resource of the plurality of additional resources having an additional highest received power.

4. The UE of claim 1, wherein the one or more processors are configured to cause the UE to:
receiving a calibration reference signal configuration from the network entity, wherein the calibration reference signal configuration comprises at least one of a number of the plurality of resources, a time and frequency location of each of the plurality of resources, a repetition factor of the uplink calibration reference signal, a frequency hopping parameter of the uplink calibration reference signal, a periodicity of transmission of the uplink calibration reference signal, or report resources for the report.

5. The UE of claim 1, wherein the plurality of resources are contiguous in at least one of time or frequency.

6. The UE of claim 1, wherein the report comprises two or more resource indices, each identifying a respective resource of the plurality of resources having one of two or more highest received powers among the plurality of resources.

7. The UE of claim 1, wherein:
the first uplink precoding matrix comprises a first vector of precoding values, wherein each element of the first vector is associated with an antenna port of a plurality of antenna ports of the UE, and
each of the respective second uplink precoding matrices comprises a respective second vector of precoding values, wherein each element of each of the respective second vectors comprises a respective phase shift from a corresponding element of the first vector, wherein the respective phase shift is equal across the respective elements of a given second vector.

8. The UE of claim 7, wherein a first number of the plurality of resources is based on a second number of the plurality of antenna ports.

9. The UE of claim 7, wherein each of the plurality of resources spans at least one of a respective set of two or more time resources or a respective set of two or more frequency resources.

10. The UE of claim 1, wherein the uplink calibration reference signal comprises a set of two or more uplink calibration reference signals, each associated with a respective set of two antenna ports of a plurality of antenna ports at the UE, wherein each of the respective sets of two antenna ports comprises a first antenna port of the plurality of antenna ports and a different respective remaining antenna port of the plurality of antenna ports.

11. The UE of claim 10, wherein:
the first uplink precoding matrix comprises a vector of precoding values, wherein each element of the vector is associated with a respective antenna port of the plurality of antenna ports, and
each of the respective second uplink precoding matrices associated with a given uplink calibration reference signal of the two or more uplink calibration reference signals is associated with a same set of two respective elements of the vector corresponding to the respective set of two antenna ports for the given uplink calibration reference signal.

12. The UE of claim 10, wherein the report comprises a respective resource index for each of the two or more uplink calibration reference signals.

13. The UE of claim 10, wherein the one or more processors are configured to cause the UE to:
receiving a calibration reference signal configuration from the network entity, wherein the calibration reference signal configuration comprises a number of the two or more uplink calibration reference signals.

14. The UE of claim 10, wherein the respective plurality of resources across the two or more uplink calibration reference signals are contiguous in at least one of time or frequency.

15. The UE of claim 1, wherein the one or more processors are configured to cause the UE to:
transmit a capability of the UE to the network entity, wherein the capability indicates a number of the plurality of resources.

16. The UE of claim 1, wherein the wherein the one or more processors are configured to cause the UE to:
transmit the uplink calibration reference signal in response to a request for uplink precoding calibration by the network entity or the UE.

17. The UE of claim 1, wherein the one or more processors are configured to cause the UE to:
detect a collision between the uplink calibration reference signal and an additional uplink signal; and
apply a priority rule to the uplink calibration reference signal based on a type of the additional uplink signal.

18. A method operable at a user equipment (UE), the method comprising:
receiving a downlink reference signal from a network entity;
obtaining a first uplink precoding matrix based on the downlink reference signal;
transmitting an uplink calibration reference signal comprising a plurality of resources, wherein each of the plurality of resources is precoded with a respective second uplink precoding matrix comprising a respective phase shift from the first uplink precoding matrix; and
receiving a report from the network entity, wherein the report comprises a resource index identifying a resource of the plurality of resources having a highest received power among the plurality of resources.

19. The method of claim 18, further comprising:
identifying a phase calibration error based on the respective phase shift associated with the resource;
applying a phase error compensation matrix corresponding to the phase calibration error to the first uplink precoding matrix to produce a calibrated uplink precoding matrix; and
transmitting an uplink signal to the network entity, wherein the uplink signal is precoded with the calibrated uplink precoding matrix.

20. An apparatus configured for wireless communication, comprising:
means for receiving a downlink reference signal from a network entity;
means for obtaining a first uplink precoding matrix based on the downlink reference signal;
means for transmitting an uplink calibration reference signal comprising a plurality of resources, wherein each of the plurality of resources is precoded with a respective second uplink precoding matrix comprising a respective phase shift from the first uplink precoding matrix; and
means for receiving a report from the network entity, wherein the report comprises a resource index identifying a resource of the plurality of resources having a highest received power among the plurality of resources.
